(19) United States
(12) Patent Application Publication
(10) Pub. No.: US 2012/0329033 A1
(43) Pub. Date: Dec. 27, 2012

(54) BEAUTY-RELATED INFORMATION COLLECTION AND DIAGNOSIS USING ENVIRONMENTS

(75) Inventor: Daniela Giacchetti, Paris (FR)

(73) Assignee: L'Oreal S.A., Paris (FR)

(21) Appl. No.: 13/536,607

(22) Filed: Jun. 28, 2012

Related U.S. Application Data
(63) Continuation of application No. 10/746,250, filed on Dec. 29, 2003, now abandoned.

(51) Int. Cl. G09B 25/00

(52) U.S. Cl. 434/377

(57) ABSTRACT

Features and principles of the present invention relate to a method of generating a beauty-related diagnosis for an individual. The method may comprise collecting personal beauty care information, and generating a beauty-related diagnosis according to the collected information. Collecting may comprise causing a presentation of an environment associated with personal beauty care information to be collected, and receiving the personal beauty care information. The personal beauty care information may correspond to at least one object in the environment.

The present application generally relates to the following concurrently filed U.S. patent applications, which are incorporated herein by reference: Beauty-Related Diagnostic Methods and Systems (Attorney Docket No. 05725.1230); and Beauty-Related Diagnostic Accessible Via Multiple Access Sites (Attorney Docket No. 05725.1232).

### BACKGROUND

1. Technical Field

The present invention generally relates to methods and systems for collecting beauty-related information and/or providing beauty-related diagnoses.

2. Related Art

For various reasons, there are numerous challenges associated with collecting consumer information and providing appropriate products and services (e.g., cosmetics, health products, salon services, etc.) to consumers in beauty-related fields. These challenges are compounded as the number of products and services and the consumer demand for these products and services increase. For example, the variety of services and products offered by some providers (e.g., cosmetic manufacturers, spas, salons, department stores, etc.) can sometimes approach thousands, possibly even tens of thousands. If competing providers offer similar services or products, a typical consumer becomes overwhelmed by her array of possible choices between all of the services and products available in the marketplace. Accordingly, it would be beneficial to provide a convenient way for a. consumer to learn what services and products best suit her. Further, from a provider's perspective, it would be beneficial to provide an efficient mechanism to collect accurate information from consumers and potential consumers, so that the provider may understand the consumers' needs, perform consumer research, and/or market appropriate services and products to particular individuals.

### SUMMARY

In the following description, certain aspects and embodiments of the present invention will become evident. It should be understood that the invention, in its broadest sense, can be practiced with or without one or more features described in these aspects and embodiments. The aspects and embodiments are merely exemplary.

One aspect of the invention relates to a method of generating a beauty-related diagnosis for an individual. The method may include collecting personal beauty care information and generating a beauty-related diagnosis according to the collected information. The collecting may include causing a presentation of an environment associated with personal beauty care information to be collected, and receiving the personal beauty care information, wherein the personal beauty care information corresponds to at least one object in the environment.

In another aspect, the environment may be a virtual environment and/or an image of an actual environment. In some examples, causing a presentation of an environment may include causing a presentation of a virtual environment associated with the personal beauty care information to be collected, and the personal beauty care information may correspond to at least one virtual object in the virtual environment. For example, the environment may include a bathroom, a salon, a bedroom, and/or a spa. Some examples may include an environment including a facsimile of a bathroom mirror, a bathroom cabinet, a bathroom shelf, and/or a bathroom sink (e.g., the object may be near the facsimile).

In a further aspect, the environment may include a facsimile of a person that uses at least one of a product and a service for personal beauty care.

In yet another aspect, the object may represent a product and/or a service for personal beauty care. In some examples, the method may include providing information on at least one of the product and the service for personal beauty care.

In one other aspect, the object may be a facsimile of the product in the environment. For example, the product a moisturizer, lotion, cream, oil, spray, make-up, cleanser, soap, and/or wash.

In one more aspect, the object may be generated in the environment according to information provided by a user for at least one of an unlisted product and an unlisted service.

In another aspect, the object may be manipulated to provide the personal beauty care information. For example, the object may be manipulated by moving the object to at least one predetermined location, e.g., a predetermined location associated with at a time of usage, a schedule of usage, and/or a frequency of usage for at least one of the product and the service. In some examples, the object may be manipulated by selecting the object.

In a further aspect, the personal beauty care information may include a time of usage, a schedule of usage, and/or a frequency of usage for at least one of the product and the service. In some examples, the personal beauty care information may include at least one season of usage for at least one of the product and the service.

In another aspect, the method may further include receiving information relating to a beauty condition. For example, the beauty condition may include a hair style, a hair color, a hair condition, a skin type, a skin condition, and/or a skin tone.

In one more aspect, the personal beauty care information may include at least one of a type of product and a type of service.

In still another aspect, the personal beauty care information may include a bathroom regimen, a salon regimen, and/or a spa regimen.

According to a further aspect, the method may further include evaluating a good personal beauty care practice and/or a bad personal beauty care practice from the personal beauty care information. In some examples, the method may further include presenting information about at least one of the good personal beauty care practice and the bad personal beauty care practice.

In accordance with another aspect, the personal beauty care information may be received, at least in part, via a network. For example, the network may be a wide-area network, a local area network, and/or an Internet.

In yet another aspect, the personal beauty care information may be received, at least in part, at a point-of-sale location for a beauty care product and/or a beauty care service.

According to one more aspect, the beauty-related diagnosis may include an evaluation of the individual's beauty care regimen.

In a further aspect, the beauty-related diagnosis may include advice to modify the individual's beauty care regimen. For example, the advice may include a beauty care product recommendation and/or a beauty care service recommendation.

Another aspect related to a method for collecting personal beauty care information: The method may include causing a presentation of an environment associated with personal beauty care information to be collected, and receiving the personal beauty care information, wherein the personal beauty care information corresponds to at least one object in the environment. In some examples, the object may represent at least one of a product and a service for personal beauty care, and the personal beauty care information may include a time of usage, a schedule of usage, and/or a frequency of usage for at least one of the product and the service. Some examples may include personal beauty care information including a bathroom regimen, a salon regimen, and/or a spa regimen.

A further aspect relates to a system for generating a beauty-related diagnosis for an individual. The system may include a processor and a memory, wherein the processor and the memory may be configured to perform any of the method described herein.

One more aspect relates to a computer-readable medium containing instructions to configure a processor to perform any of the methods described herein.

An additional aspect relates to a user interface for collecting personal beauty care information. The user interface may include a display area presenting a environment associated with personal beauty care information to be collected, and a beauty care input area receiving the personal beauty care information, wherein the personal beauty care information corresponds to at least one object in the environment, and wherein the user interface is associated with generation of a beauty-related diagnosis for an individual.

In another aspect, the beauty care input area may be associated with a time of usage, a schedule of usage, and/or a frequency of usage for at least one of a personal beauty care product and a personal beauty care service.

One more aspect relates to a method for providing a beauty-related diagnosis. The method may include viewing a presentation of an environment associated with personal beauty care information to be input; inputting the personal beauty care information, wherein the personal beauty care information corresponds to at least one object in the environment; and receiving information reflecting a beauty-related diagnosis generated according to the input personal beauty care information.

Still another aspect may related to a database including beauty care information collected in any method described herein.

A further aspect relates to a method for providing personal beauty care information. The method may include manipulating an object in an environment associated with personal beauty care information to be input, wherein the object may be manipulated in at least one of a plurality of differing manners, and wherein personal beauty care information may be input according to the manner in which the object is manipulated. In some examples, manipulating the object includes moving the object to at least one of a plurality of predetermined locations. For example, at least one of the predetermined locations may be associated with a time of usage, a schedule of usage, and/or a frequency of usage for at least one of a product and a service.

Aside from the procedural and structural arrangements set forth above, the invention could include a number of other arrangements such as those explained hereinafter. It should be understood that both the foregoing description and the following description are exemplary only.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIGS. 1A and 1B illustrate exemplary portal websites, consistent with features and principles of the present invention;

FIG. 2 illustrates an exemplary client-server system, consistent with features and principles of the present invention;

FIG. 3 illustrates an exemplary client station or server, consistent with features and principles of the present invention;

FIG. 4 illustrates an exemplary method for generating a beauty-related diagnosis, consistent with features and principles of the present invention;

FIG. 5 illustrates an exemplary login screen, consistent with features and principles of the present invention;

FIGS. 6A-7K illustrate exemplary screenshots requesting and providing preliminary information, consistent with features and principles of the present invention;

FIG. 8 illustrates exemplary topic modules, consistent with features and principles of the present invention;

FIG. 9 illustrates exemplary sub-topic modules for a face module, consistent with features and principles of the present invention;

FIGS. 10A-10G illustrate exemplary information requests for a sub-topic module, consistent with features and principles of the present invention;

FIG. 11A illustrates an exemplary sub-topic diagnosis, consistent with features and principles of the present invention;

FIGS. 11B and 11C illustrate exemplary information available after completing a sub-topic diagnostic, consistent with features and principles of the present invention;

FIG. 12 illustrates an exemplary topic diagnosis, consistent with features and principles of the present invention;

FIG. 13 illustrates an exemplary generic prescription, consistent with features and principles of the present invention;

FIG. 14 illustrates an exemplary request for brand and venue preferences, consistent with features and principles of the present invention;

FIG. 15 illustrates an exemplary brand-specific prescription, consistent with features and principles of the present invention;

FIG. 16 illustrates another exemplary method of generating a beauty-related diagnosis, consistent with features and principles of the present invention;

FIG. 17 illustrates another exemplary method of generating a beauty-related diagnosis, consistent with features and principles of the present invention;

FIG. 18 illustrates an exemplary inconsistency, consistent with features and principles of the present invention;

FIG. 19 illustrates an exemplary beauty diagnostic method, consistent with features and principles of the present invention;

FIG. 20 illustrates exemplary evaluative gestures, consistent with features and principles of the present invention;

FIG. 21A illustrates requests to perform self-evaluative gestures, consistent with features and principles of the present invention;

FIG. 21B illustrates an exemplary algorithm for determining firmness using evaluative gestures, consistent with features and principles of the present invention;

FIG. 22 illustrates an exemplary method for facilitating evaluation of a beauty-related product and/or treatment, consistent with features and principles of the present invention;

FIG. 23 illustrates an exemplary virtual environment, consistent with features and principles of the present invention;

FIG. 24 illustrates another exemplary method of generating a beauty-related diagnosis, consistent with features and principles of the present invention;

FIG. 25 illustrates an exemplary face care routine diagnosis, consistent with features and principles of the present invention;

FIG. 26 illustrates an exemplary for collecting personal beauty care information, consistent with features and principles of the present invention;

FIG. 27 illustrates another exemplary for collecting personal beauty care information, consistent with features and principles of the present invention;

FIG. 28 illustrates an exemplary method for providing a beauty-related diagnosis, consistent with features and principles of the present invention;

FIG. 29 illustrates an exemplary method for providing personal beauty care information, consistent with features and principles of the present invention;

FIG. 30 illustrates an exemplary brand-specific website, consistent with features and principles of the present invention;

FIG. 31 illustrates exemplary topic modules at a brand-specific website, consistent with features and principles of the present invention;

FIG. 32 illustrates an exemplary prescription at a brand-specific website, consistent with features and principles of the present invention;

FIGS. 33-36 illustrate exemplary methods of facilitating access to a beauty diagnostic, consistent with features and principles of the present invention; and

FIG. 37 illustrates another exemplary beauty diagnostic method, consistent with features and principles of the present invention.

### DETAILED DESCRIPTION

Reference is now made in detail to exemplary embodiments of the invention, examples of which are illustrated in the accompanying drawings. Wherever possible, the same reference numbers are used throughout the drawings to refer to the same or like parts.

According to features and principles of the present invention, an individual may visit a website associated with a diagnostic engine. The diagnostic engine may request information from the individual about her lifestyle, beauty care habits, etc. and generate a beauty-related diagnosis according to that information. The diagnostic engine may provide a beauty profile to the individual according to the generated beauty-related diagnosis. Further, the diagnostic engine may prescribe specific actions, services, and/or products that the individual might use to maintain and/or improve her beauty. Also, if the individual wishes to do so later on, she may update her diagnosis by again accessing the diagnostic engine via the website or via some other mechanism.

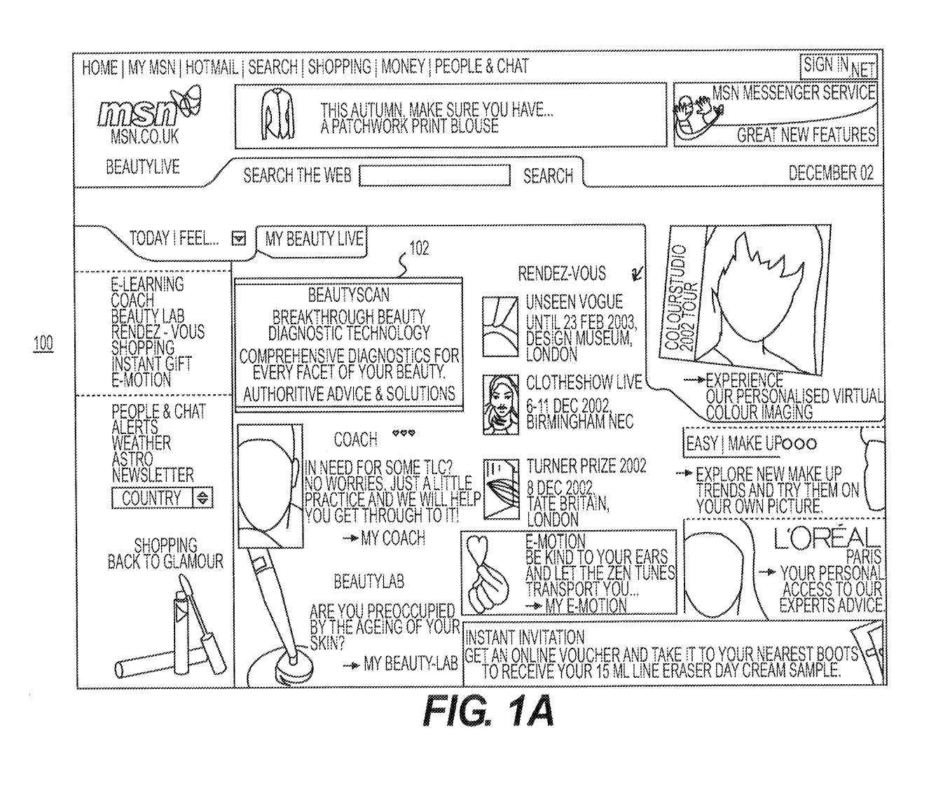

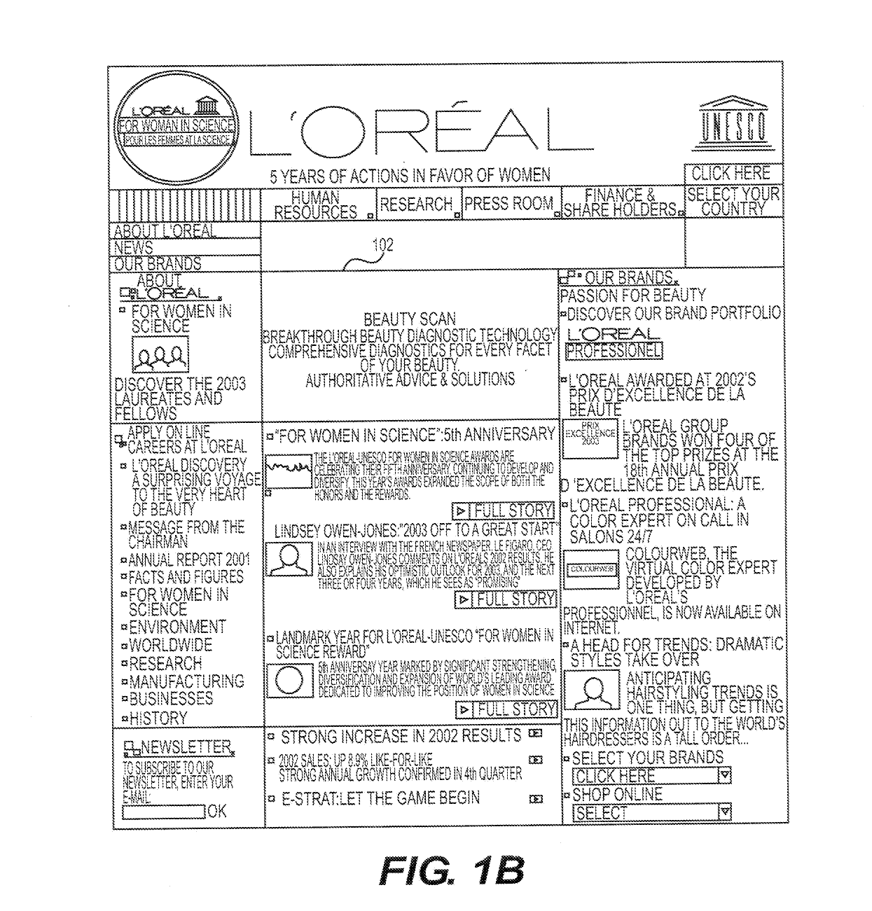

The website may be a portal website or any other website providing a variety of resources and services that might be of interest to the individual. For example, FIGS. 1A and 1B illustrate exemplary web pages 100 and 150 with a diagnostic engine 102 (i.e., BeautyScan) accessible by the individual at exemplary portal websites, Microsoft Network™ and L'OREAL, respectively. Web pages 100 and 150 each offer diagnostic engine 102 as a resource available to an individual along with other resources (e.g., search engine, electronic forums, e-mail, shopping, etc.). The individual may access diagnostic engine 102 by selecting the BeautyScan block on web page 100 or 150, or by any other mechanism compatible with features and principles of the invention.

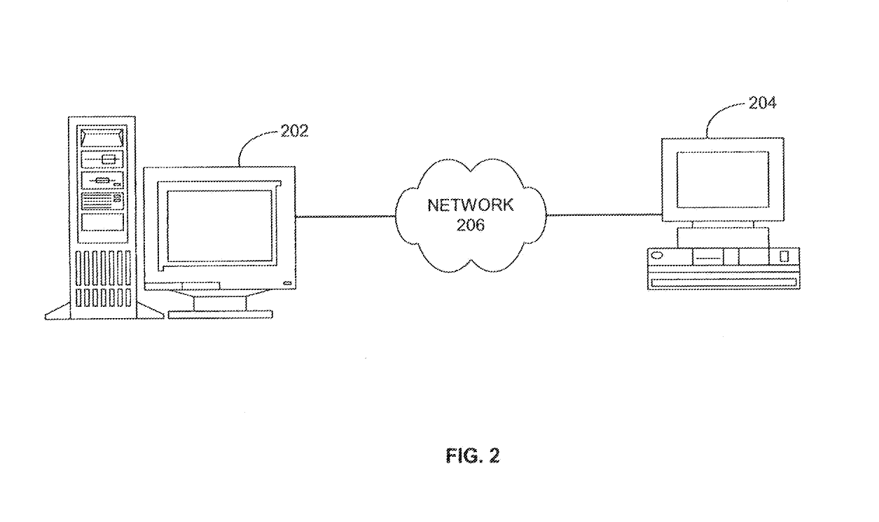

Diagnostic engine 102 may be a tool implemented in Basic, Visual Basic, C, C++, Visual C, Java, HTML, FORTRAN, Pascal, COBOL, LISP, assembly language, machine code, firmware, or any other programming or computer-readable language. Diagnostic engine 102 may be stored, at least partially, on a server 202 illustrated in FIG. 2. Once an individual accesses diagnostic engine 102, server 202 may execute diagnostic engine 102. An individual may access diagnostic engine 102 via a client station 204 or some other device. Diagnostic engine 102 may also be stored, at least partially, on client station 204 and may be partially downloaded and/or installed on client station 204 prior to, during, or after an individual accesses diagnostic engine 102. Server 202 and client station 204 may work together or independently to execute diagnostic engine 102. Client station 204 may be located at a kiosk, a point-of-sale, a household, a supermarket, a department store, a pharmacy, a spa, a salon, an office, and/or any other location compatible with features and principles of the present invention.

Server 202 may use diagnostic engine 102 to collect information from an individual via client station 204 and network 206 to provide a beauty-related diagnosis to the individual. Server 202 may also use diagnostic engine 102 to collect consumer information from a plurality of individuals for research purposes (e.g., via multiple client stations or any other devices) and may store the consumer information in a database. Network 206 may comprise a local area network, a wide area network, an intranet, an extranet, the Internet, a telephone network, and/or any other medium for communicating between locations.

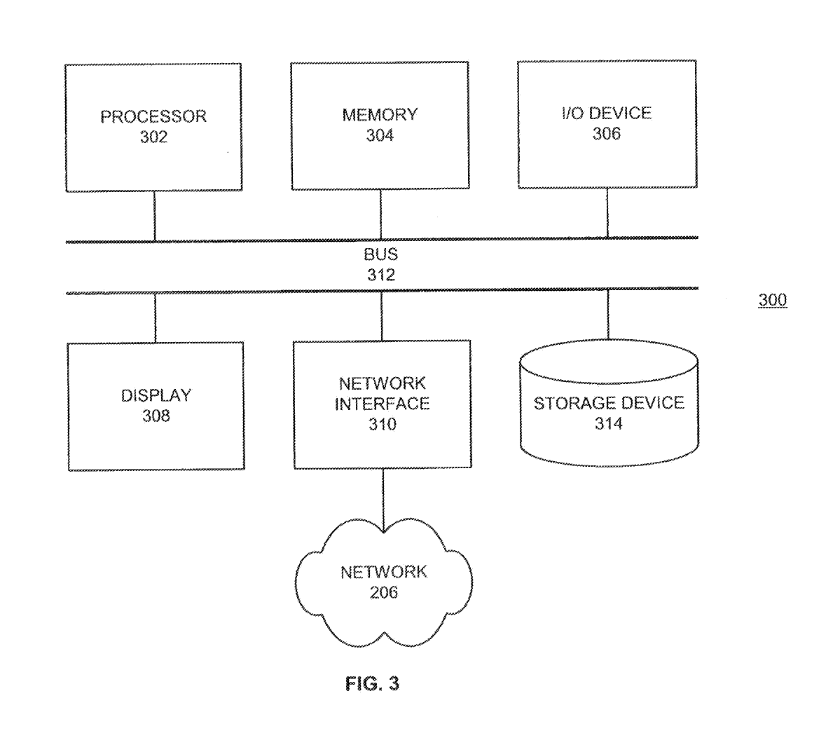

As illustrated by system 300 in FIG. 3, the server and client station may each comprise a processor 302, a memory 304, an input/output (I/O) device 306, a display 308, a network interface 310, a bus 312, and/or a persistent storage device 314. Processor 302, memory 304, I/O device 306, display 308, network interface 310, and storage device 314 may be configured to communicate over bus 312.

Processor 302 may comprise a mainframe, a laptop, a personal computer, a workstation, a computer chip, a digital signal processor board, an analog computer, a plurality of processors, and/or any other information processing device or combination of devices. Further, processor 302 may be implemented by a general purpose computer or data processor selectively activated or reconfigured by a stored computer program, or may be a specially constructed computing platform for carrying out certain features and operations disclosed herein. Memory 304 may comprise random access memory, read-only memory, flash memory, and/or any other information storage device. I/O device 306 may comprise a keyboard, a mouse, a trackball, a light pen, an electronic tablet, and/or any other mechanism that can provide information to system 300. Display 308 may comprise a cathode-ray-tube monitor, a plasma screen, a liquid-crystal-display screen, and/or any other device for conveying information from system 300. Network interface 310 may comprise an Ethernet card, a FDDI card, a modem, and/or any other mechanism for interfacing to a network. Bus 312 may comprise a data cable, a circuit board connection, a fiber optic line, a network, a serial connection, a parallel connection, and/or any other mechanism for conveying information between processor 302, memory 304, I/O device 306, display 308, network interface 310, and/or storage device 314. Storage device 314 may comprise a hard drive, a tape drive, a RAID disk array, a database system, and/or any other device or system that persistently stores information.

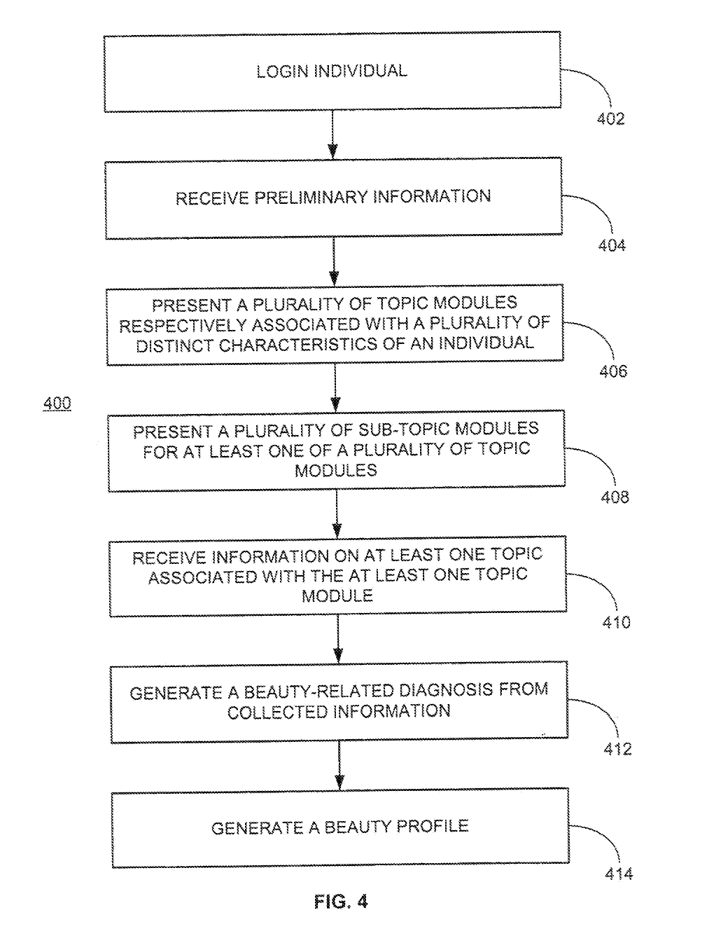

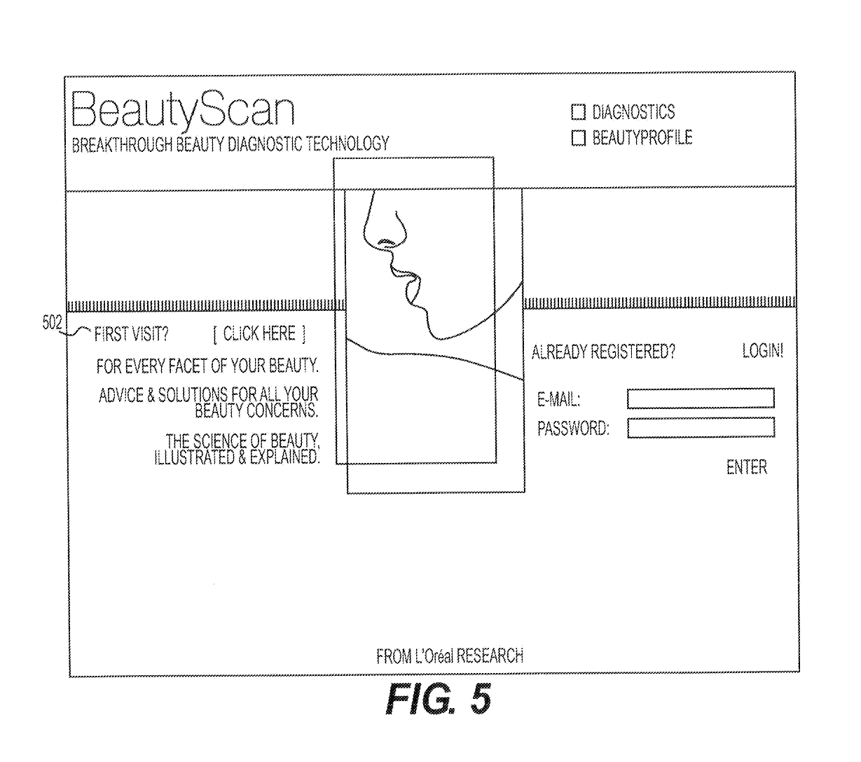

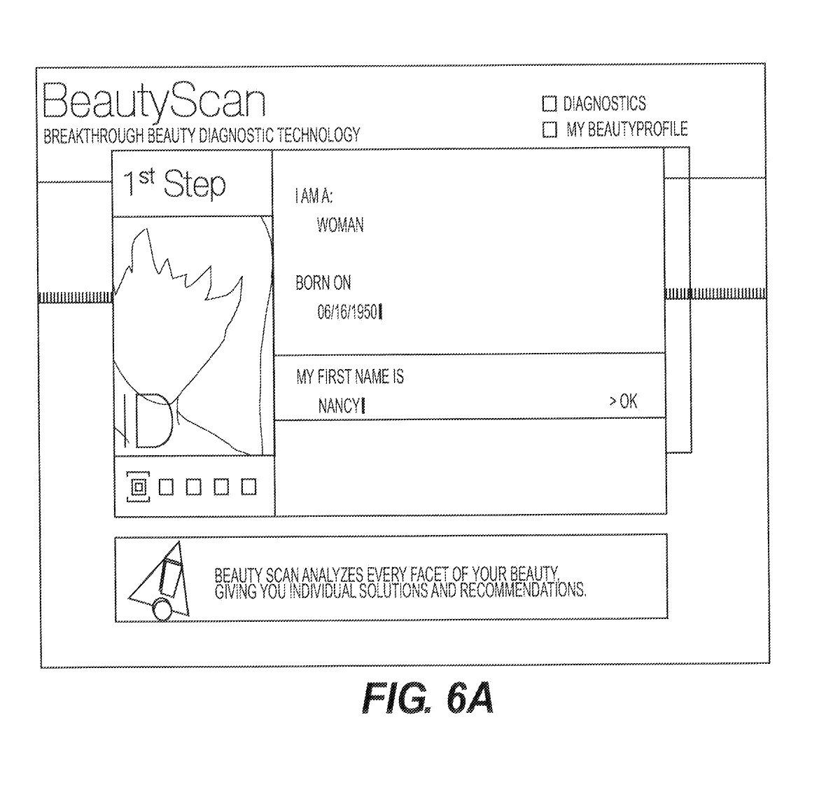

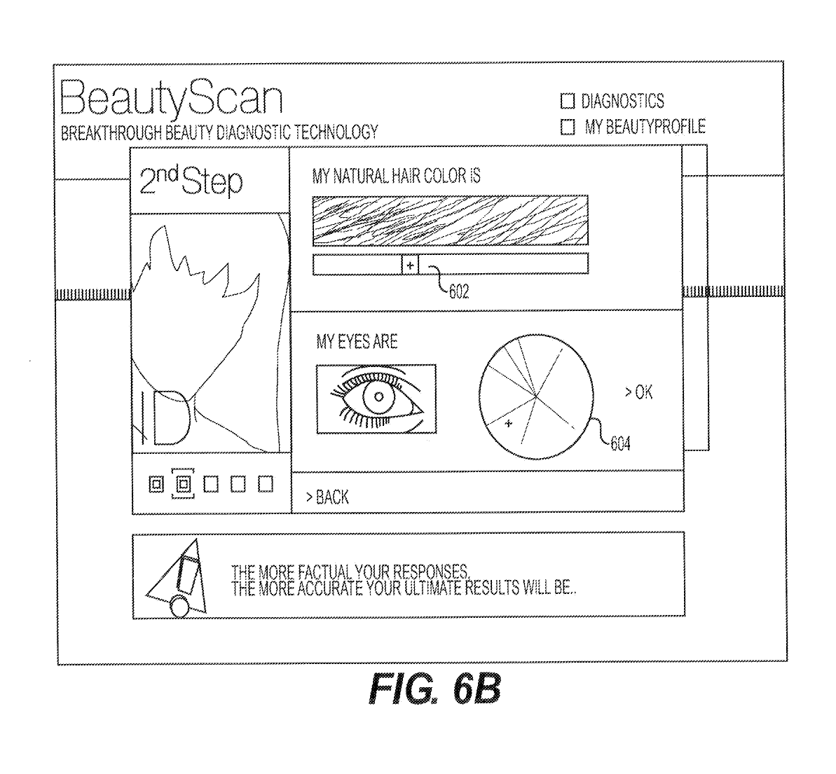

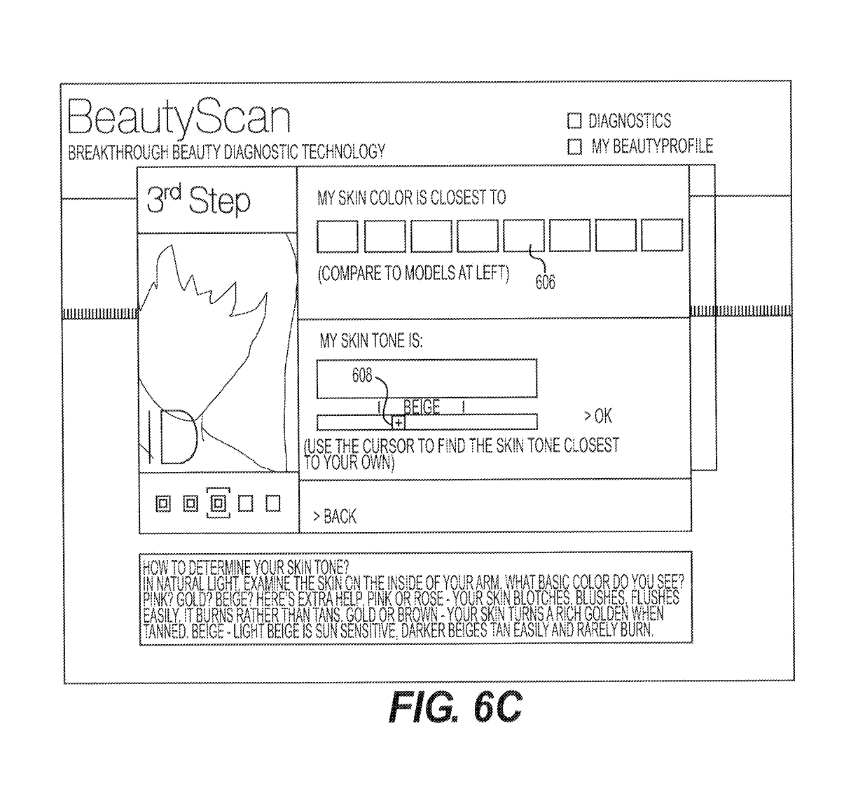

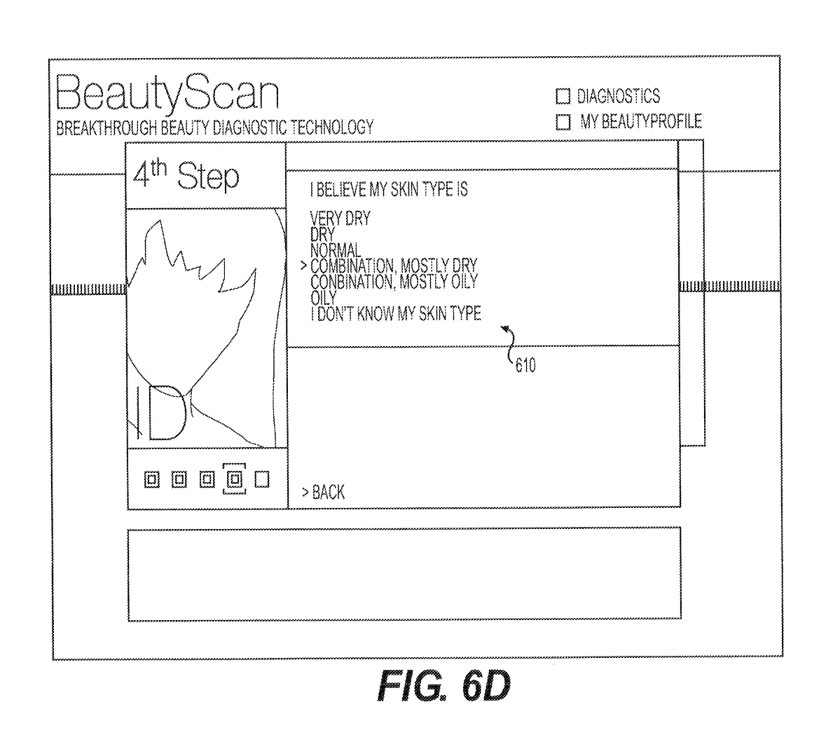

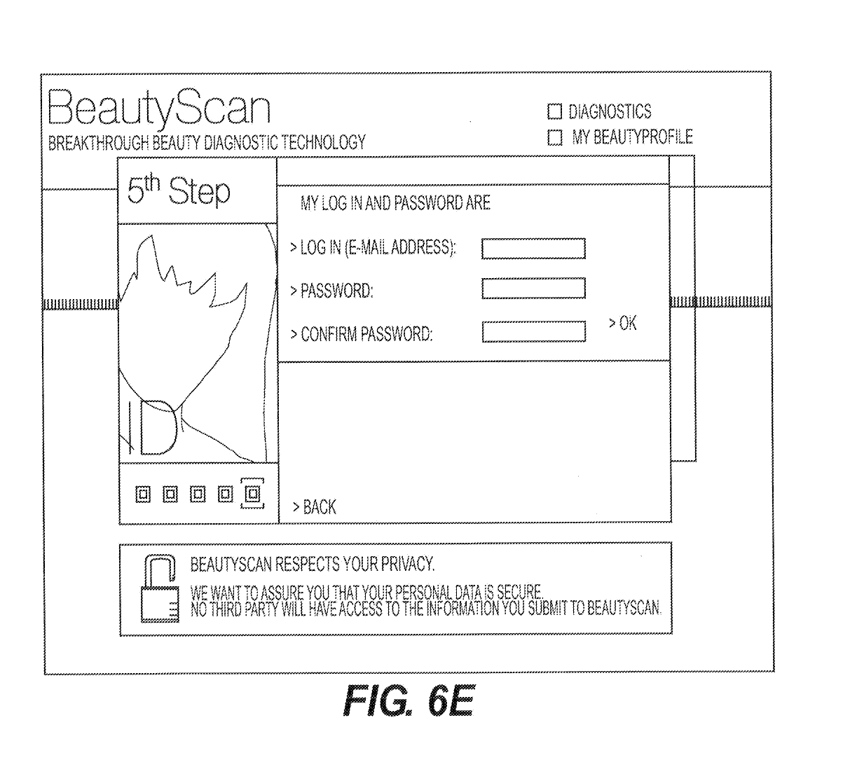

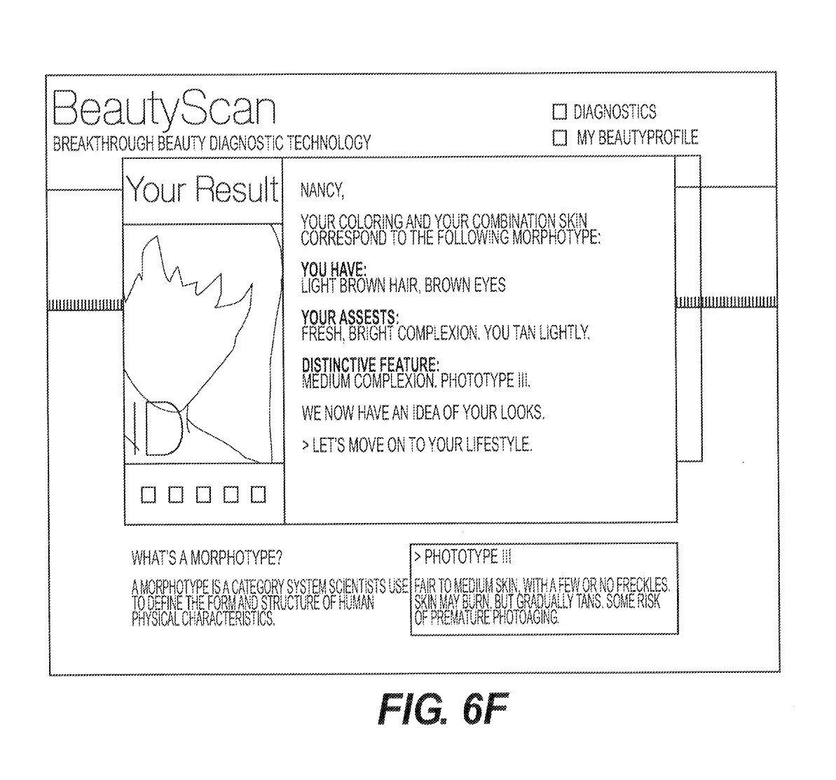

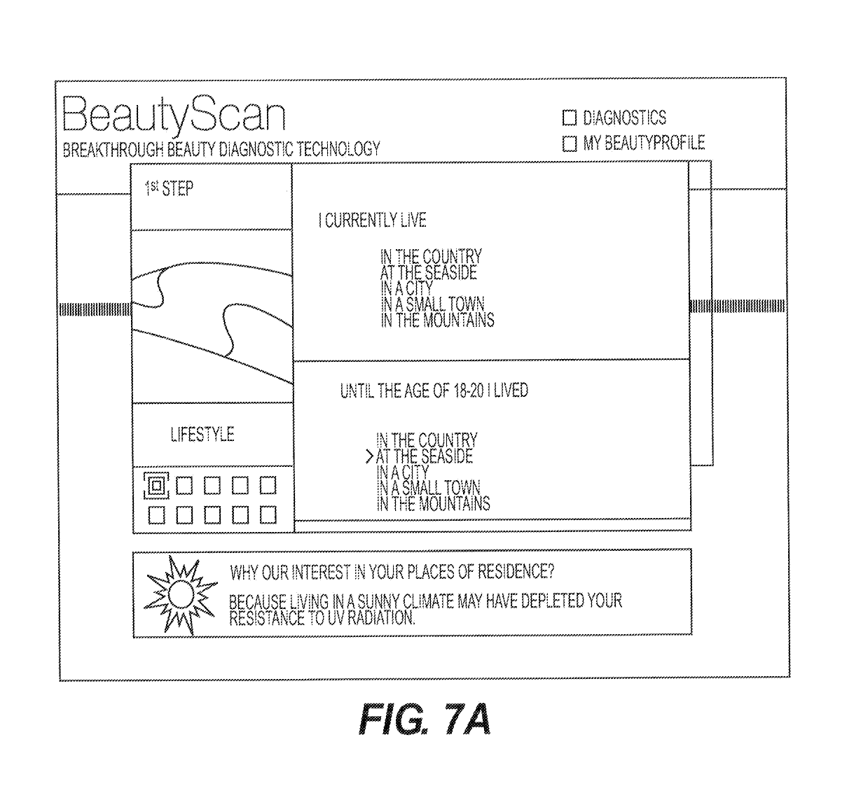

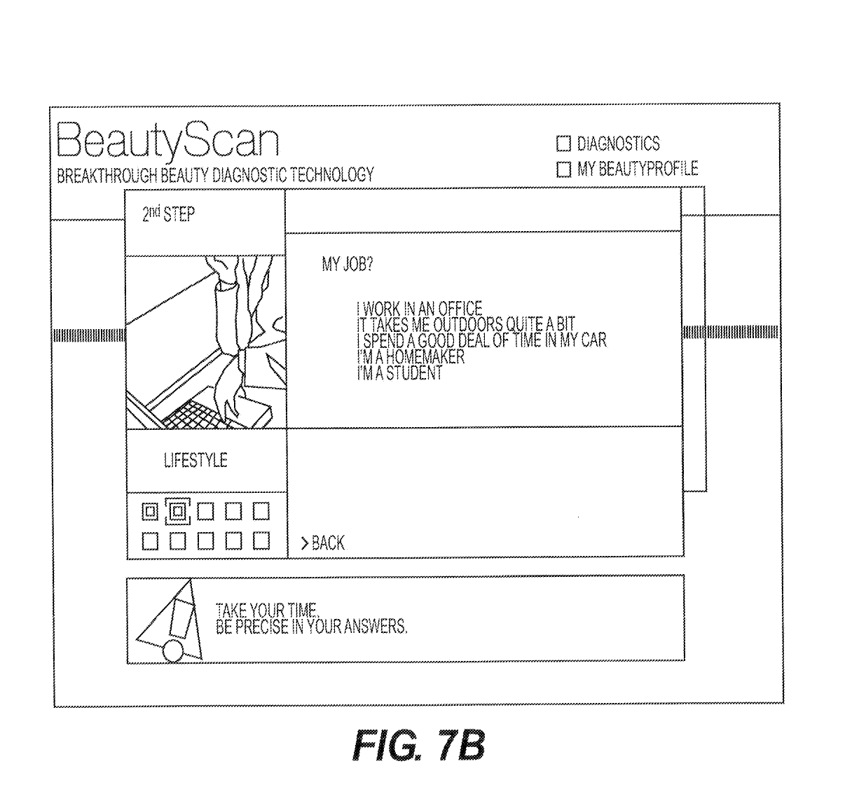

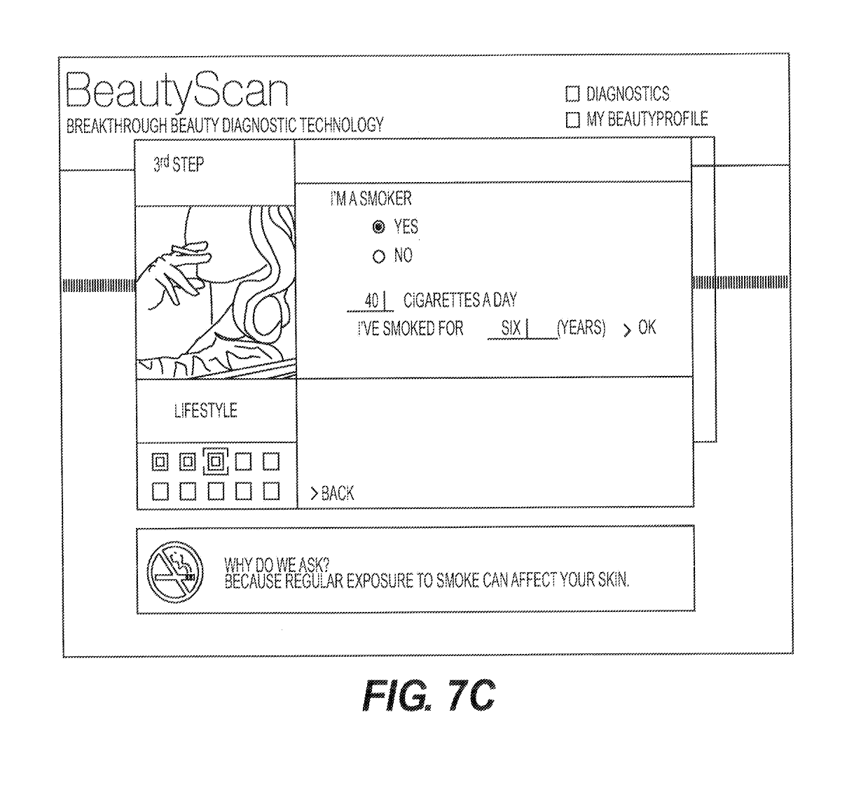

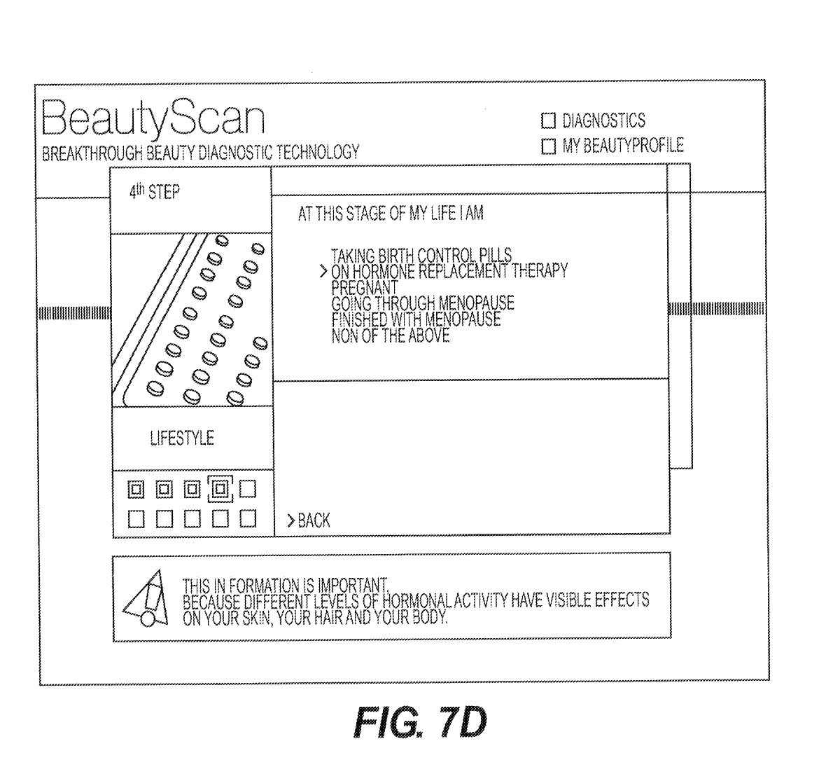

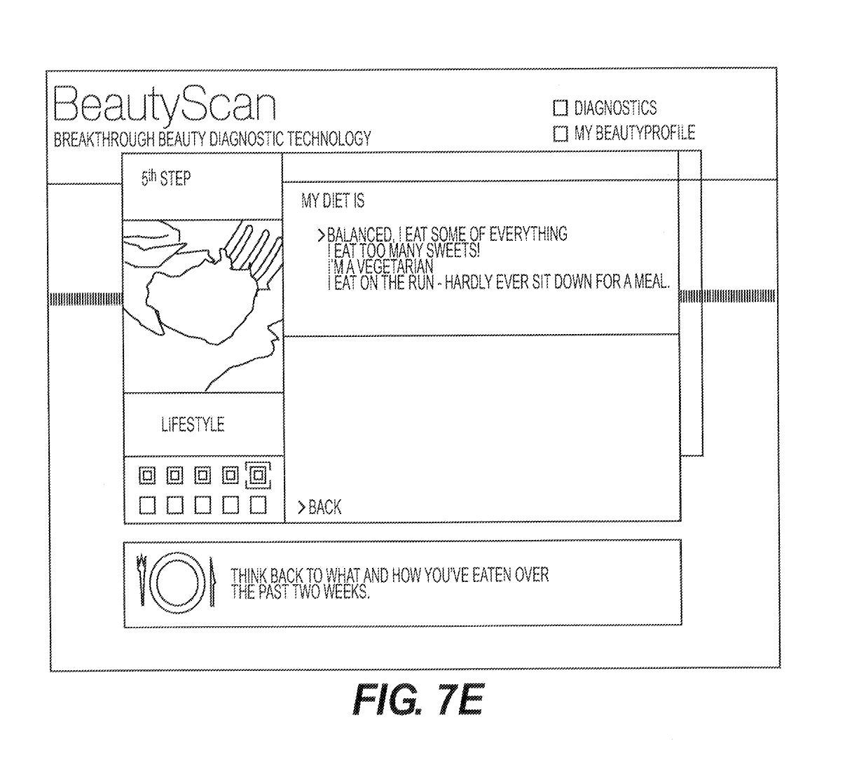

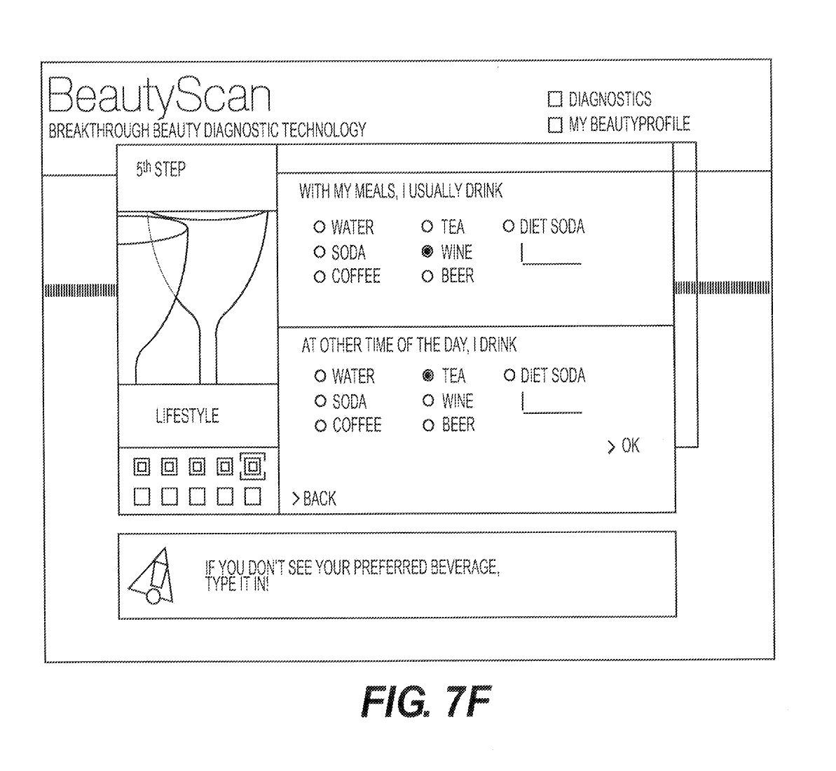

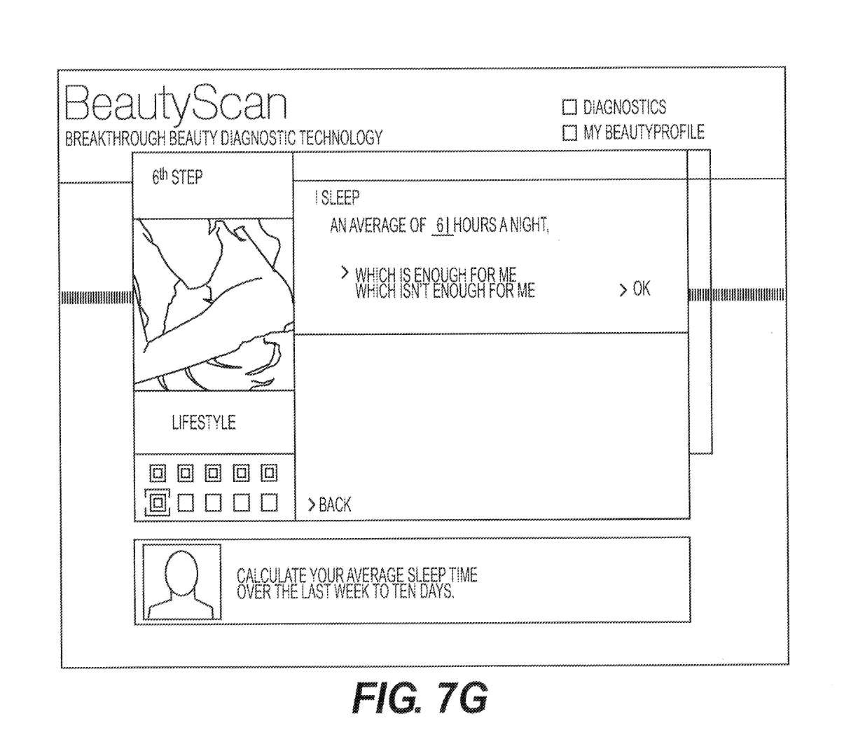

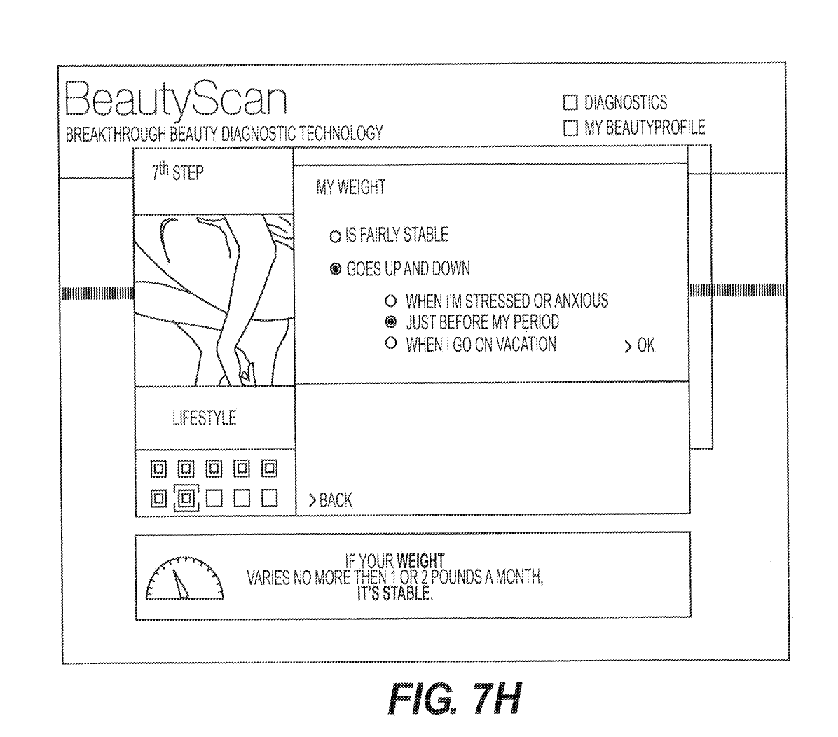

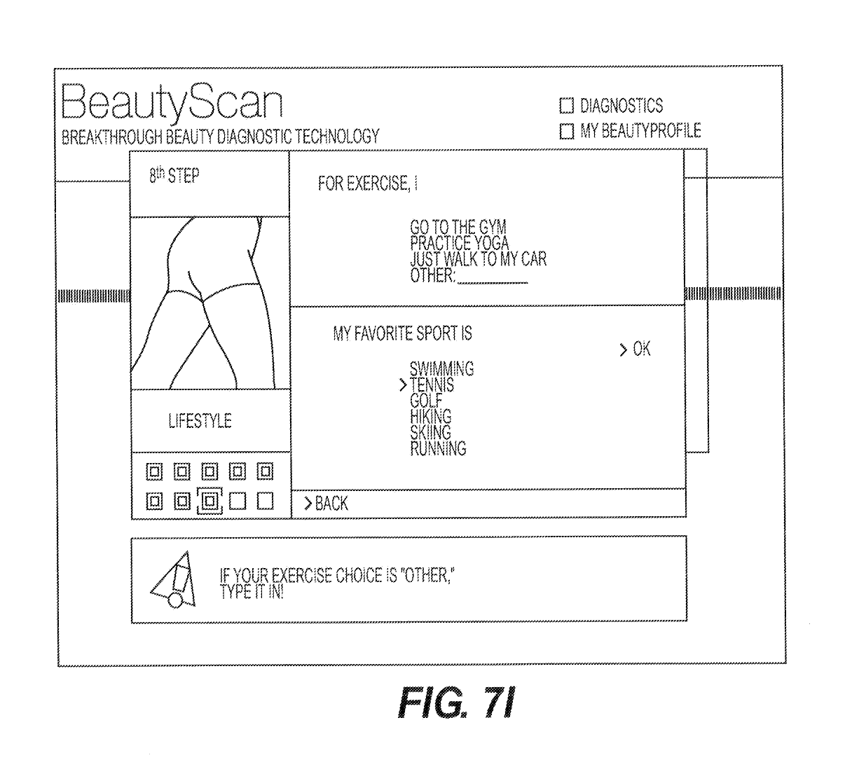

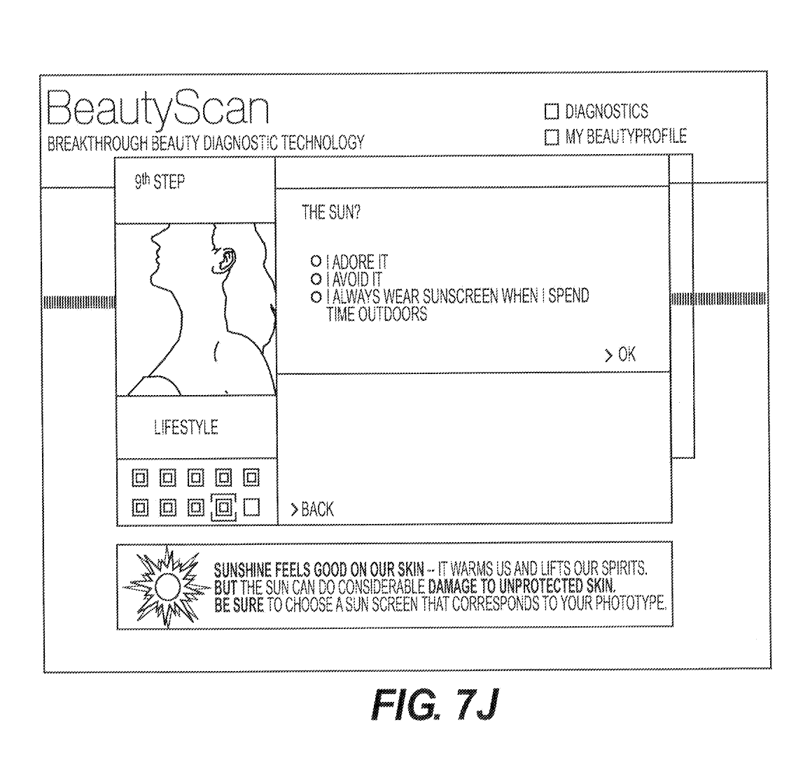

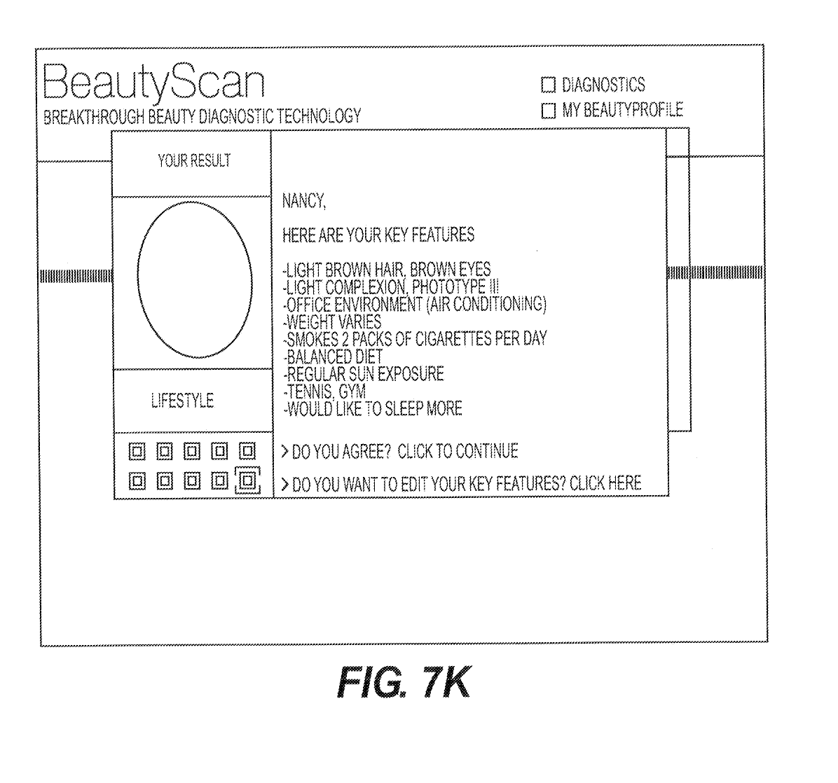

According to features and principles of the present invention, when an individual accesses diagnostic engine 102, server 202 may generate a beauty-related diagnosis for the individual according to a method 400 illustrated in FIG. 4. Method 400 may comprise logging in the individual (step 402), as illustrated in FIG. 5. If the individual is using diagnostic engine 102 for the first time, then the individual may select a first visitor option 502, and server 202 may request and receive preliminary information from the individual (step 404), as illustrated in FIGS. 6A-7K.

The preliminary information may comprise personal information. Personal information may include information relating to the individual's name, gender, birthday, age, etc., as shown in FIG. 6A. Personal information may include information relating to the individual's hair (e.g., hair color, hair length, etc.), eyes (e.g., eye color, eye redness, etc.), etc. For example, as shown in FIG. 6B, server 202 may ask the individual to indicate her natural hair color and/or eye color using a sliding color bar 602 or color wheel 604, respectively. Personal information may include information relating to the individual's skin (e.g., color, tone, type, etc). For example, as shown in FIGS. 6C and 6D, server 202 may ask the individual to indicate her skin color, skin tone, and skin type using color palette 606, sliding color bar 608, and selectable choices 610, respectively. Personal information may include contact information, login information, etc., as shown in FIG. 6E, information relating to morphotype, phototype, and/or any other relevant or possibly relevant personal information.

After server 202 receives the personal information, server 202 may provide a summary and a brief analysis of the personal information to the individual via client station 204 before collecting further preliminary information. For example, server 202 may specify that the individual has light brown hair, brown eyes, a fresh complexion, a bright complexion, lightly tanning skin, a medium complexion, a phototype of three, as illustrated in FIG. 6F, and/or any other relevant personal information.

The preliminary information may comprise lifestyle information, such as information relating to the individual's past and/or present living environment, job, etc., as illustrated in FIGS. 7A and 7B; smoking habit, as illustrated in FIG. 7C; fertility, reproductive system, etc., as illustrated in FIG. 7D; diet, drinking habit, sleeping habit, etc., as illustrated in FIGS. 7E-7G; weight, exercise habit, etc., as illustrated in FIGS. 7H-7I; sun exposure, as illustrated in FIG. 7J; and/or any other relevant and/or possibly relevant lifestyle information. After server 202 receives the lifestyle information, it may provide a summary and a brief analysis of the lifestyle information to the individual via client station 204. For example, as illustrated in FIG. 7K, server 202 may indicate the individual's key lifestyle features include light brown hair, brown eyes, light complexion, phototype III, working in an office environment, variable weight, heavy smoking, balanced diet, regular sun exposure, tennis, exercise at a gym, lack of sleep, and/or any other information related to the individual's lifestyle.

Once server 202 receives preliminary information from the individual, the server 202 may store the information (e.g., in memory 304 and/or storage device 314 of FIG. 3) to enable the individual to access diagnostic engine 102 in the future without having to provide the same preliminary information again, unless the individual wishes to update the preliminary information and/or there is new preliminary information required by server 202. Alternatively or additionally, the preliminary information may be stored in a portable storage device (e.g., floppy disk, compact disk (CD), electronic card, magnetic card, flash card, memory stick, small memory device, etc.).

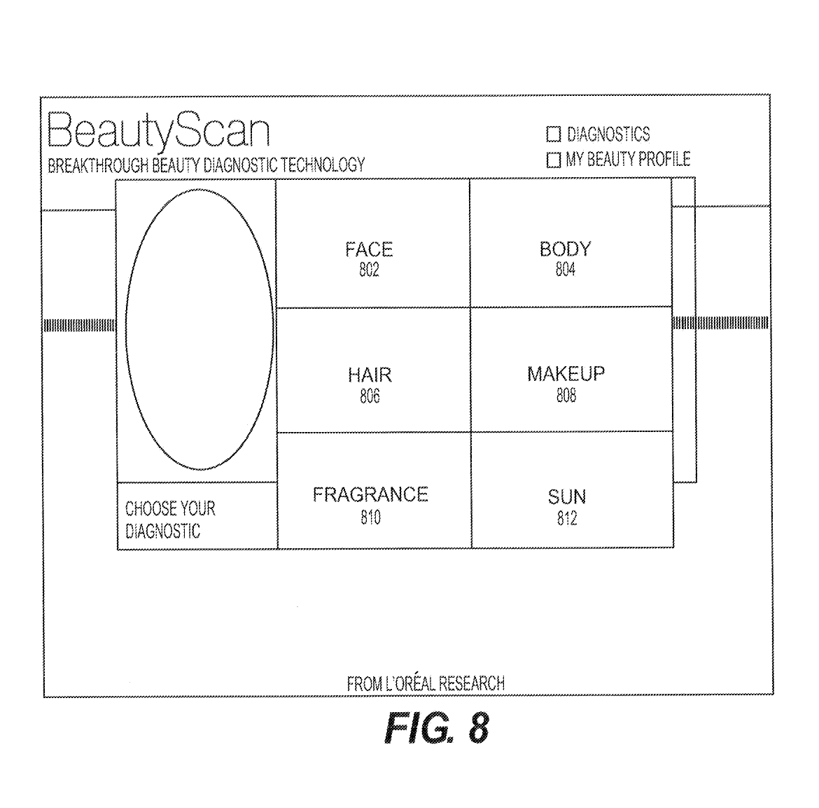

According to features and principles of the present invention, server 202 may present a plurality of topic modules respectively associated with distinct characteristics of the individual (step 406 in FIG. 4). The individual may select one or more of the topic modules for execution. The topic modules may be associated with distinct body portions of the individual (e.g., face, body, hair, nails, hands, skin, etc.) and may be used to provide a beauty-related diagnosis for distinct characteristics and/or body portions of the individual. The distinct characteristics may be related to the individual's face, body, hair, makeup, fragrance, sun exposure, and/or any other characteristic. For example, as illustrated in FIG. 8, the topic modules may include a face module 802, a body module 804, a hair module 806, a makeup module 808, a fragrance module 810, a sun module 812, and/or any other type of module.

Server 202 may customize the number, type, and content of the topic modules according to the preliminary information received at step 404 (FIG. 4). For example, server 202 may decide not to present fragrance module 810 because server 202 may determine from the preliminary information and/or other previously received information, that the individual has no interest in, does not need to use, and/or should not use fragrance module 810. Similarly, server 202 may decide available portions (e.g., sub-topic modules (described below), portions of sub-topic modules, etc.) of fragrance module 810 should not be included or presented to the individual.

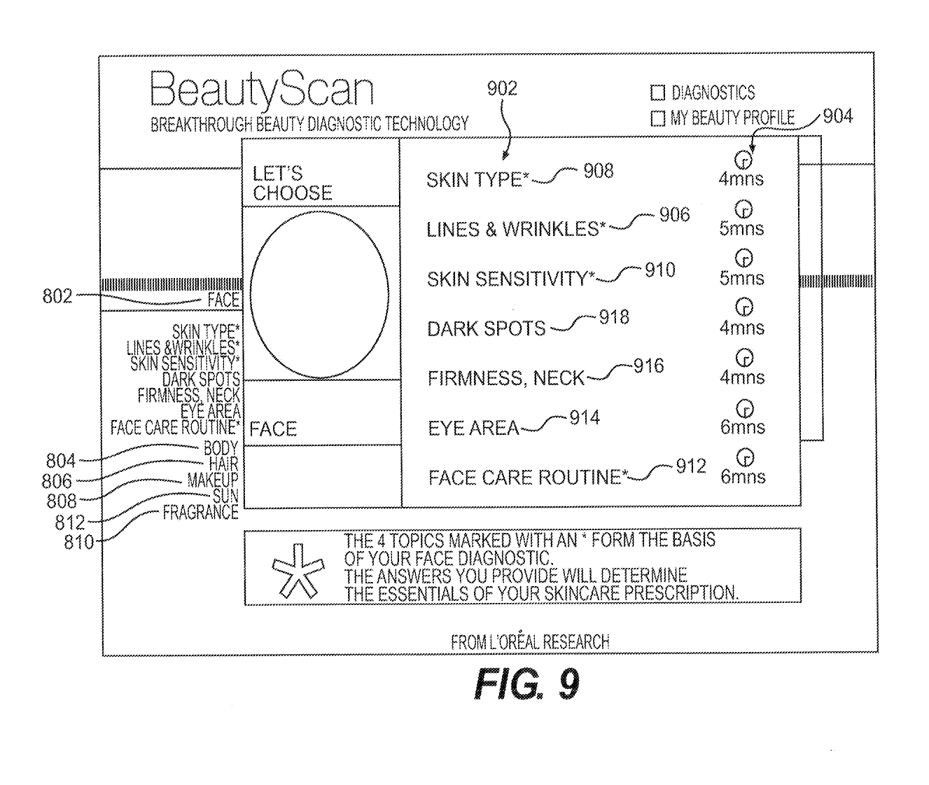

One or more of the topic modules may comprise sub-topic modules. For example, as illustrated in FIG. 9, face module 802 may comprise a skin type module 908, a wrinkles module 906, a skin sensitivity module 910, a dark spot module 918, a firmness module 916, an eye contour module 914, a face care routine module 912, an age-of-skin module (not shown), and/or any other sub-topic module related to the skin. A body module may comprise a firmness module, a hydration module, a cellulite module, a perspiration module, a hands and nails module, a body care routine module, and/or any other module related to the body. A hair module may comprise a hair condition module, a scalp condition module, a hairstyle module, a hair color module, a hair care routine module, and/or any other module related to hair. A makeup module may comprise a facial structure module, a skin tone module, a warm and cool colors module, a virtual makeover module, a makeup routine module, and/or any other module related to makeup or cosmetics. A sun module may comprise a phototype module, a sun-and-you module, a photoaging module, a natural resistance module, and/or any other module related to sun exposure. A fragrance module may comprise a moods-and-scents module, a stress module, a scent selector module, a skin pH module, and/or any other module related to fragrances or scents.

According to features and principles of the present invention, server 202 may present a plurality of sub-topic modules for at least one of the plurality of topic modules (step 408 in FIG. 4) and receive information on at least one topic associated with the at least one topic module (step 410). The received information may comprise information collected using fewer than all of the presented sub-topic modules for the at least one topic module. For example, as illustrated in FIG. 9, an individual accessing diagnostic engine 102 from client station 204 may select a face module 802 (FIGS. 8 and 9) and server 202 may present a list of sub-topic modules 902 associated with face module 802 to the individual. The individual may then select and complete one or more sub-topic modules from list 902 to provide face-related information to server 202.

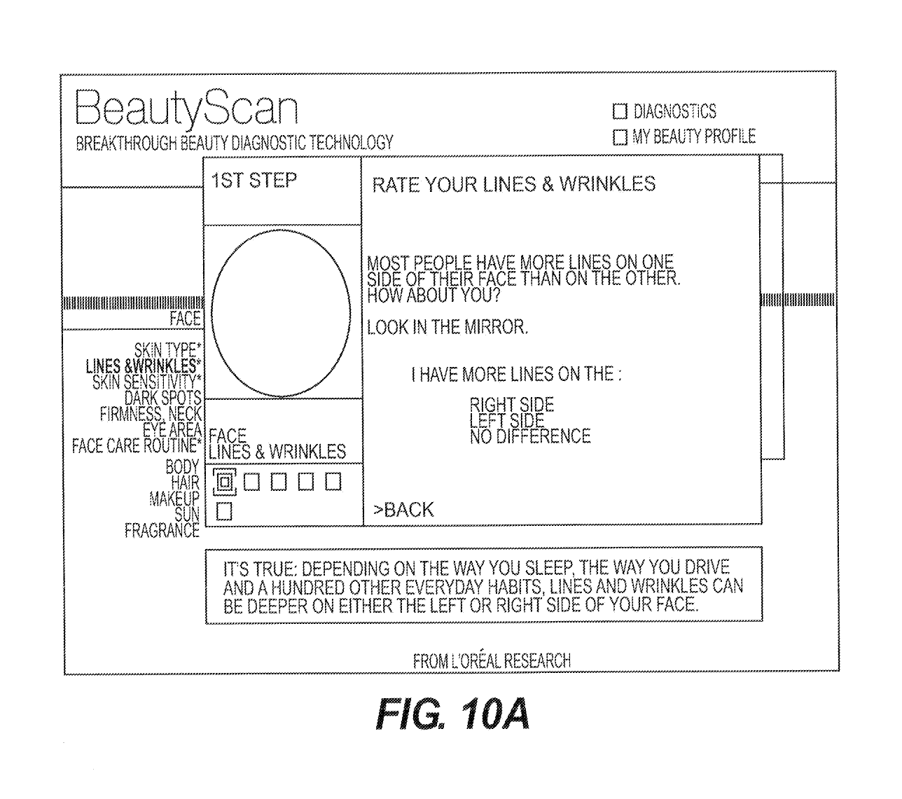

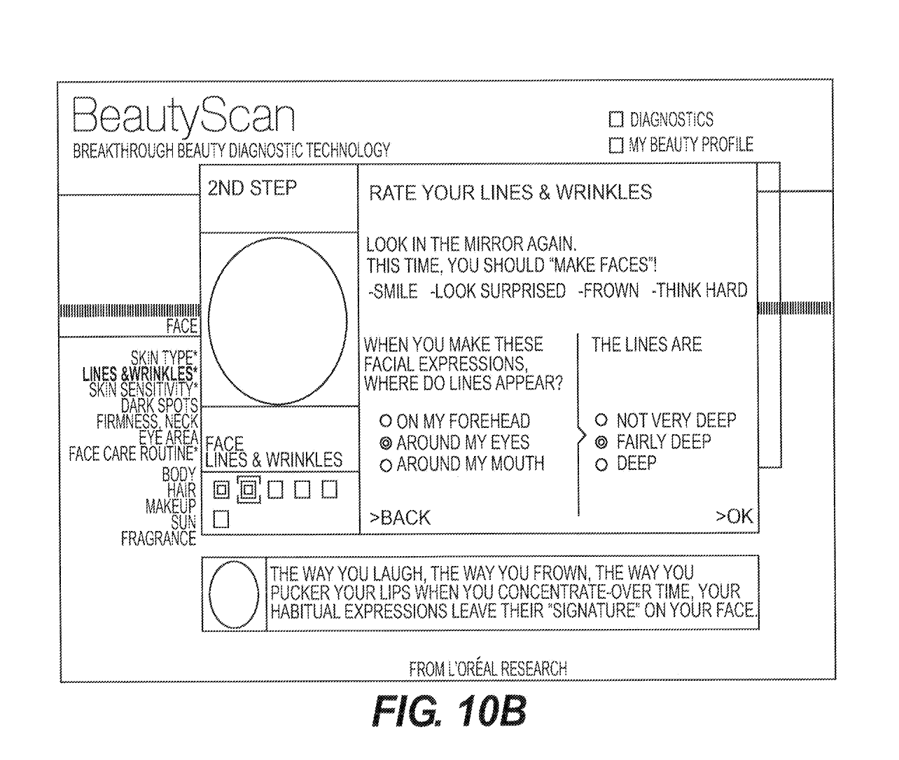

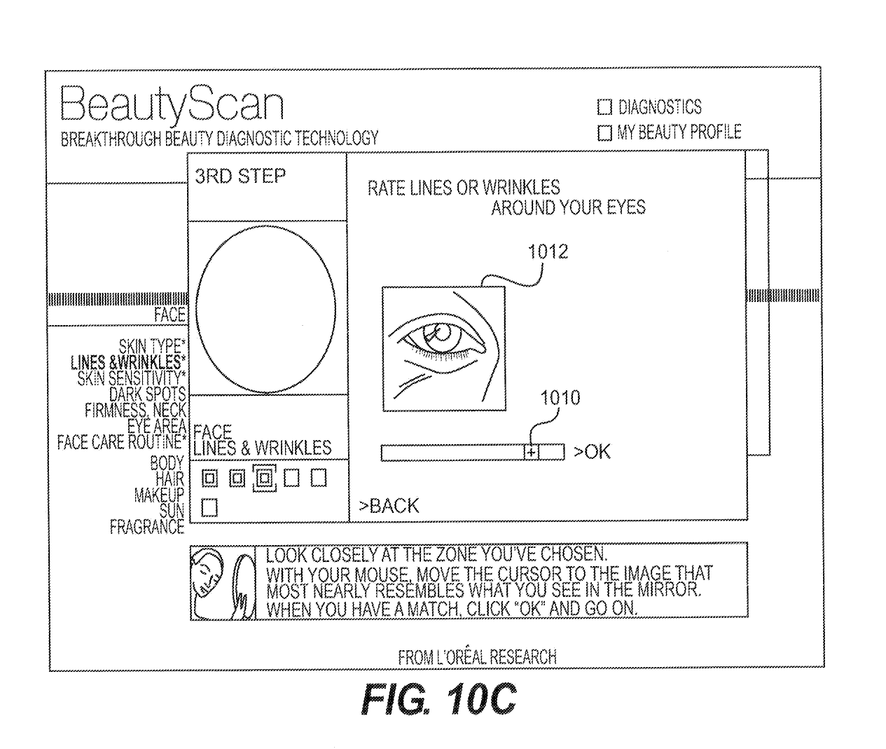

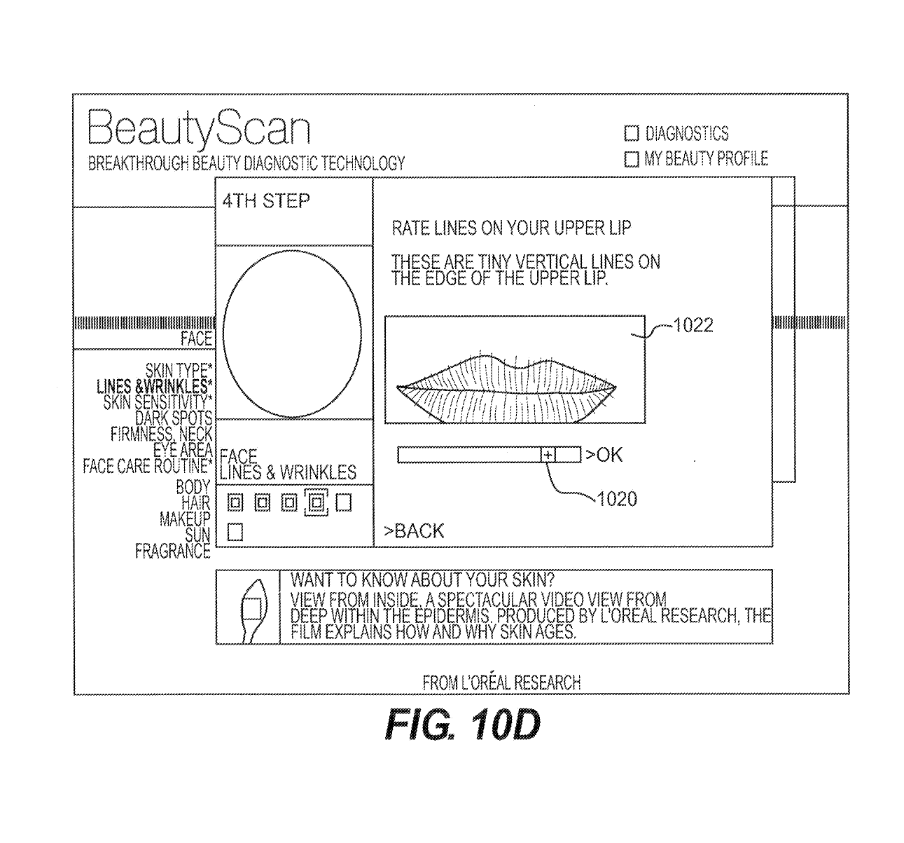

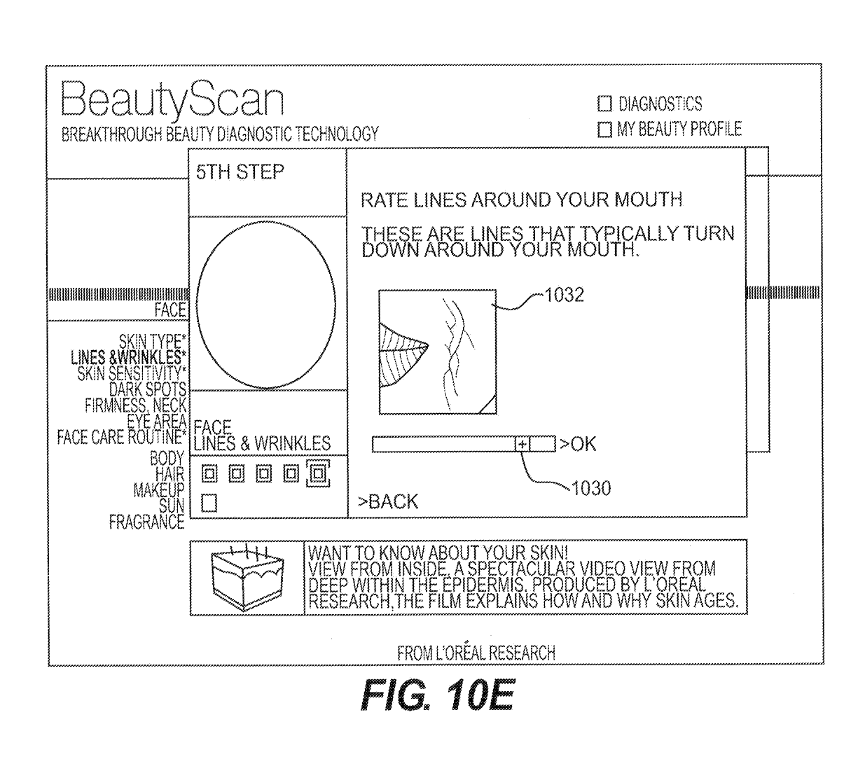

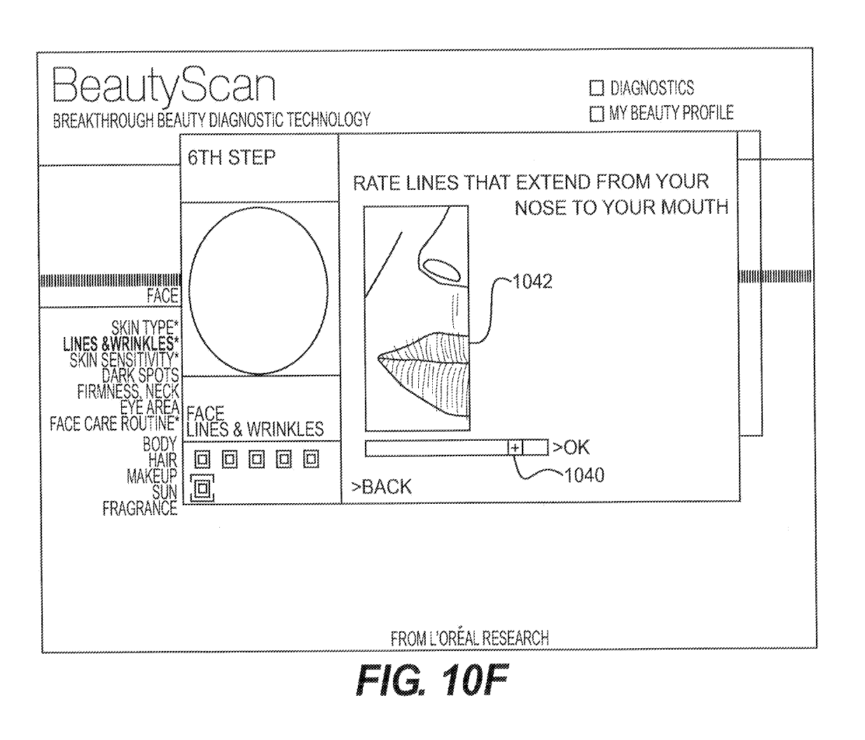

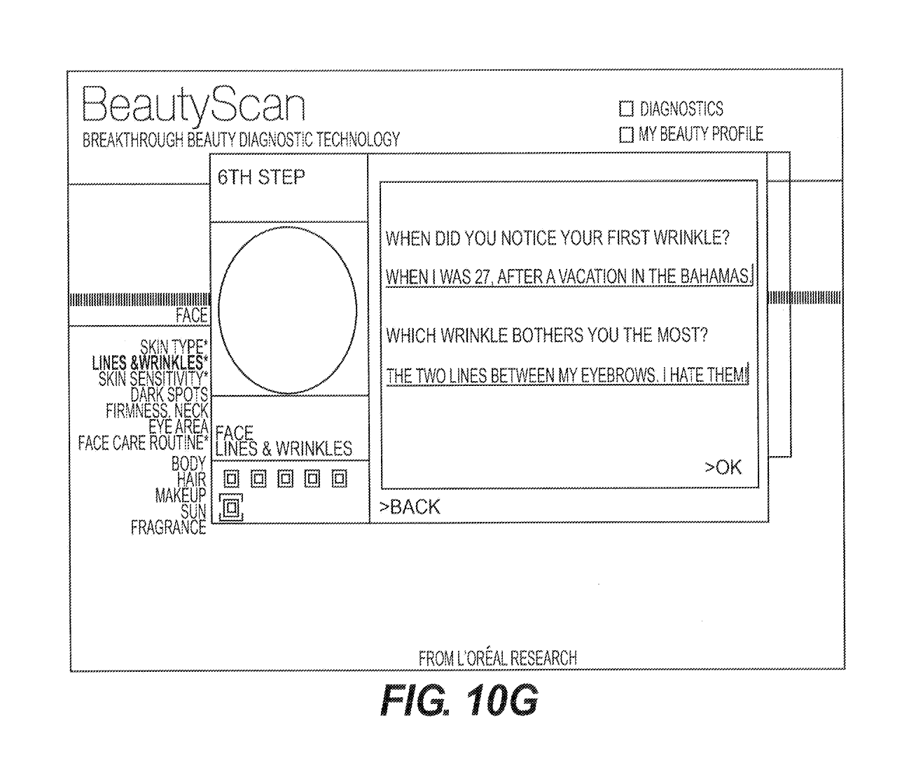

Server 202 may use one or more of the presented sub-topic modules to request information associated with the sub-topic and then generate a respective sub-topic diagnosis. Server 202 may present an estimated time 904 (FIG. 9) to complete a respective sub-topic module and/or to generate a sub-topic diagnosis using the respective sub-topic module. For example, wrinkles module 906 may require approximately five minutes to complete. As illustrated in FIGS. 10A-10G, wrinkles module 906 may comprise a plurality of questions requesting information related to the number, location, severity, appearance, and occurrence of the individual's wrinkles, and/or information related to the individual's feelings and opinions on her wrinkles. Each time server 202 receives the requested information, it may check the received information for inconsistencies and may ignore or attempt to correct any inconsistencies, as described later herein.

For example, server 202 may request an individual to indicate which side of her face has more lines and/or wrinkles (FIG. 10A), whether she has lines on her forehead, eyes, or mouth (FIG. 10B), and how deep her lines are (FIG. 10B). Server 202 may ask the individual to rate the wrinkles around her eyes (FIG. 10C), upper lip (FIG. 10D), mouth (FIG. 10E), and nose-to-mouth (FIG. 10F) by moving respective sliders 1010, 1020, 1030, and 1040 on slider bars. Server 202 may morph images 1012, 1022, 1032, and 1042, as the individual moves sliders 1010, 1020, 1030, and 1040, respectively, to illustrate different amounts and severity of wrinkles for her to compare and rate the wrinkles on different areas of her face. Server 202 may ask the individual when she noticed her first wrinkles and her feelings about her wrinkles (FIG. 10G).

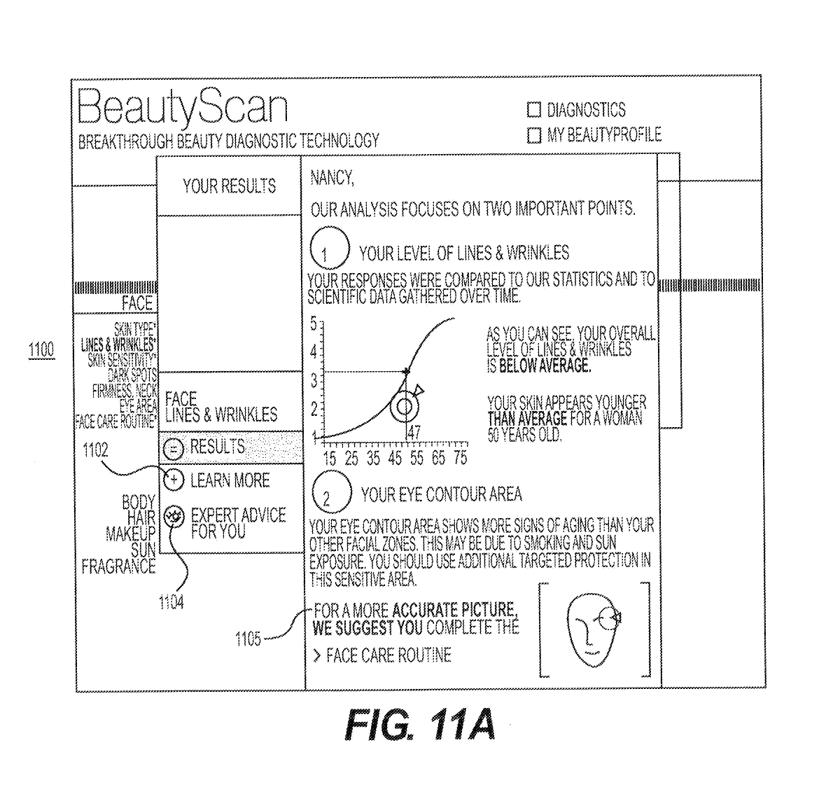

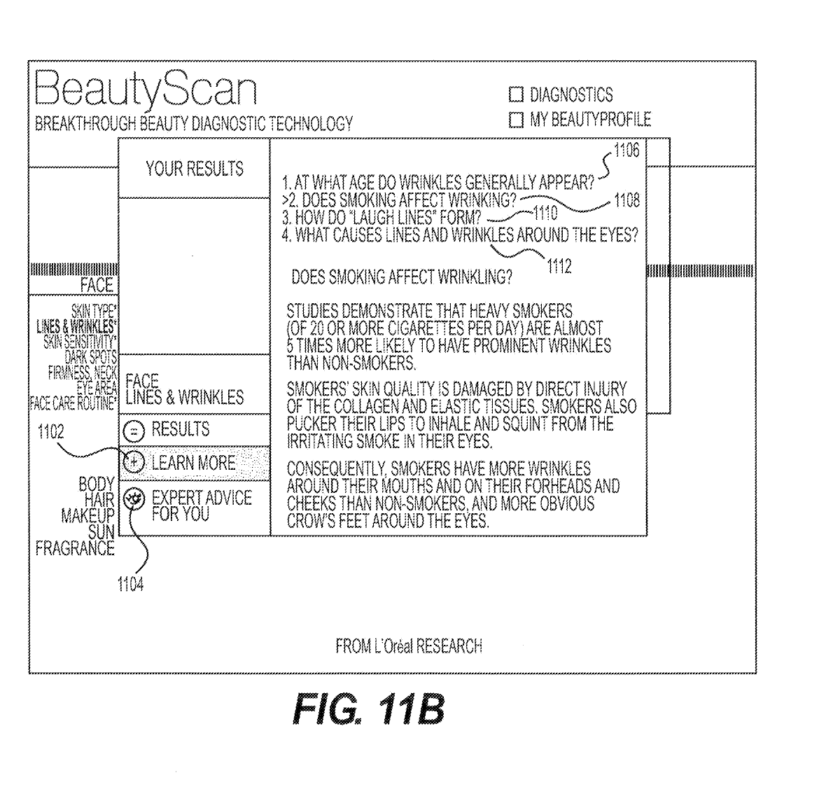

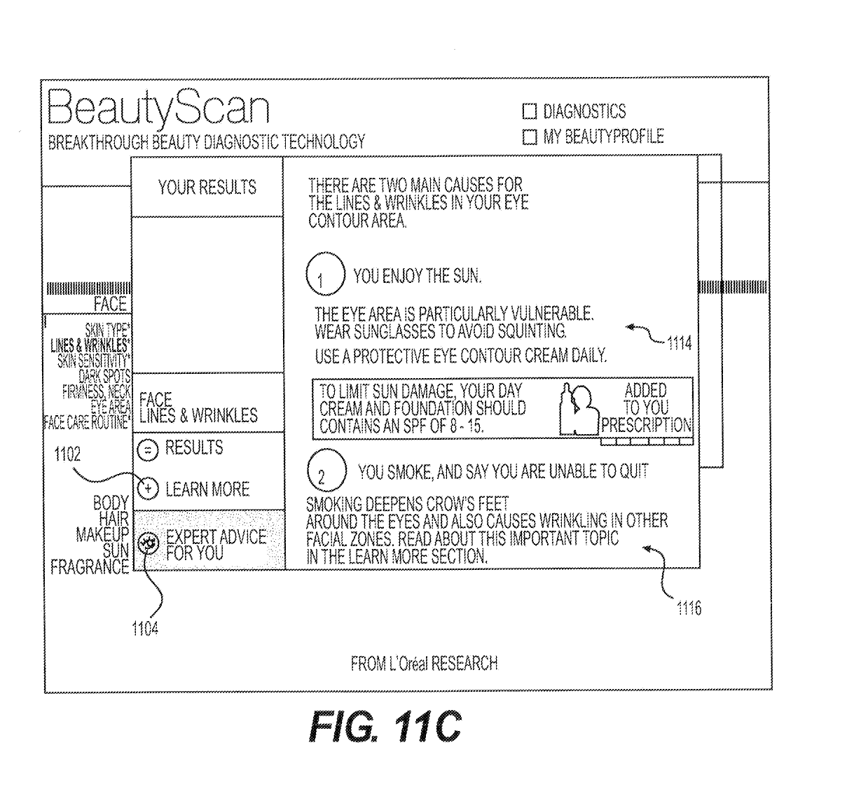

After server 202 receives requested information for a sub-topic module, it may generate a sub-topic diagnosis for the individual. For example, as illustrated in FIG. 11 A, server 202 generates a sub-topic diagnosis for the individual's wrinkles according to the answers she provided in wrinkles module 906 (FIG. 9), preliminary information from step 404 of FIG. 4, and/or any other relevant information. In this example, server 202 has determined that the individual's level of wrinkles is below average for her age, but the skin near her eyes shows more signs of aging than her other facial zones. Server 202 also causes presentation of a recommendation 1105 suggesting that the individual complete one or more other sub-topic modules (e.g., face care routine module 912 in FIG. 9) for a more accurate diagnosis (FIG. 11A).

If the individual wishes, she may request more information (e.g., educational information customized to the individual) related to the sub-topic (e.g., wrinkles) from server 202 by selecting “LEARN MORE” 1102. She may also request expert advice customized according to her sub-topic diagnosis by selecting “EXPERT ADVICE FOR YOU” 1104, as shown in FIG. 11A. In response, server 202 may provide the requested information and/or expert advice. For example, as shown in FIG. 11B, server 202 provides additional information regarding the age at which wrinkles generally appear 1106, effects of smoking on wrinkles 1108, formation of laugh lines 1110, and causes of wrinkles around the eyes 1112. Similarly, as shown in FIG. 11C, server 202 provides expert advice regarding how to counter effects of sun exposure on wrinkles around the eye 1114, and quitting cigarette smoking 1116.

According to features and principles of the present invention, server 202 may generate a beauty-related diagnosis from information collected using fewer than all of the presented sub-topic modules for a topic module (step 412 in FIG. 4). The beauty-related diagnosis may include an overall diagnosis for the individual, that incorporates information collected for one or more topics using fewer than all respective sub-topic modules for each topic. For example, an individual may only complete wrinkles module 906, skin type module 908, skin sensitivity module 910, and face care routine module 912 (FIG. 9) to generate a topic diagnosis for face module 802 (FIGS. 8 and 9). Further, in that example, the individual may only complete two out of six sub-topic modules to generate a topic diagnosis for body 804. Server 202 may then use the face and body topic diagnoses to generate an overall diagnosis without performing sub-topic diagnostics and topic diagnostics from all respective sub-topic and topic modules 802-812 (FIG. 8).

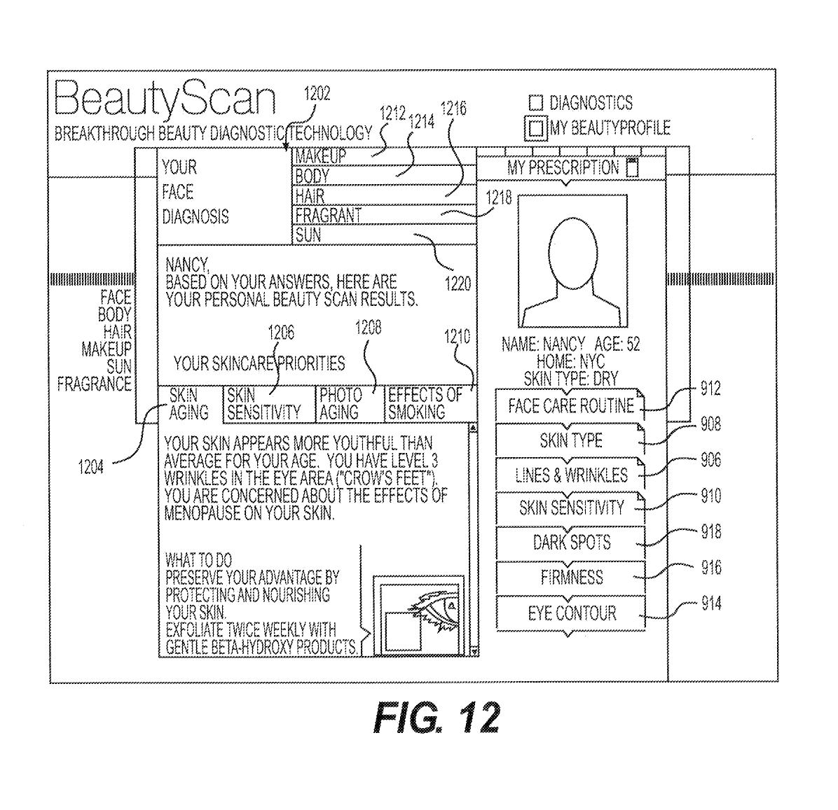

FIG. 12 illustrates an exemplary face diagnosis 1202 (i.e., a topic diagnosis) possibly generated using only sub-topic diagnoses from partially completed eye contour module 914 (FIG. 9), and fully completed wrinkles module 906, skin type module 908, skin sensitivity module 910, and face care routine module 912. In this example, server 202 possibly generated the face diagnosis using fewer than all sub-topics, one of which was only partially completed. Hence, face diagnosis 1202 could possibly be improved and further refined if the individual later completes the remaining sub-topic modules for face module 802. The improved and/or refined diagnosis may provide better face-related and/or other related information to the individual.

A topic diagnosis and/or an overall diagnosis may provide the individual with an indication of priority items determined during respective topic and/or overall diagnostics for the individual. In the above example (FIG. 12), face diagnosis 1202 includes information regarding skincare priorities, such as the individual's skin aging 1204, skin sensitivity 1206, photo aging 1208, and effects of smoking 1210. Server 202 (FIG. 2) possibly determined these priority items were most relevant according to the completed and/or partially completed sub-topic modules for the face module. The individual may request related information for each skincare priority by selecting a priority item 1204-1210. In this instance, server 202 is presenting exemplary information regarding skin aging 1204 to the individual. Server 202 indicates that the individual's skin appears more youthful than average for her age, she has level 3 wrinkles in the eye area (e.g., crow's feet), and she is concerned about the effects of menopause on her skin. Further, server 202 provides advice concerning how the individual should preserve her advantage by protecting and nourishing her skin, exfoliating her skin twice a week, etc.

Once server 202 generates a topic diagnosis, it may update the topic diagnosis using fewer than all sub-topic modules for the topic module associated with the topic diagnosis. The individual may choose to update a topic diagnosis by selecting face diagnosis 1202, makeup diagnosis 1212, body diagnosis 1214, hair diagnosis 1216, fragrance diagnosis 1218, sun diagnosis 1220, etc. From the selected diagnosis, the individual may update a sub-topic diagnosis generated from a sub-topic module associated with the topic diagnosis. In turn, server 202 may use the updated sub-topic diagnosis to update the topic diagnosis. For example, if an individual wants to update a face diagnosis, she may redo, or complete for the first time, one or more sub-topic modules 906-918 associated with the face module. Server 202 may then update the face diagnosis (i.e., a topic diagnosis) according to sub-topic diagnoses generated from the one or more sub-topic modules 906-918. Similarly, once server 202 generates an overall diagnosis, it may update the overall diagnosis using fewer than all sub-topic modules. For example, an individual may update, or complete for the first time a sub-topic module, which generates a sub-topic diagnosis. Server 202 may then use the generated sub-topic diagnosis to update a topic diagnosis corresponding to the sub-topic diagnosis. The updated topic diagnosis may then be used to update an overall diagnosis.

According to features and principles of the present invention, server 202 may generate a beauty profile for an individual (step 414 in FIG. 4). Server 202 may generate the beauty profile using at least a portion of the beauty-related diagnosis generated at step 412. Server 202 may store the beauty profile (e.g., in memory 304, storage device 314, and/or one or more of the above-mentioned portable storage devices) and make it available to the individual whenever she requests it. The beauty profile may comprise one or more of the individual's overall diagnosis, topic diagnoses, sub-topic diagnoses, priority items, focus areas, beauty recommendations, beauty advice, prescriptions, educational information, and/or other relevant information. Priority items and focus areas may be any risks, problems, and/or advantages that server 202 identified for the individual from sub-topic, topic, and overall diagnostics completed or partially completed by the individual. Priority items may comprise skin aging, skin sensitivity, photoaging, effects of smoking, combination skin, blemishes, dryness, cellulite, dark spots, foundation, eye makeup tricks, brow shaping, contouring, home coloring, choosing a hair product, thinning hair, scents for a time of day, choosing a sun protection factor, and/or ultra-violet protection.

Server 202 may provide one or more prescriptions including a product, a service, a care routine, etc. for the individual. Examples of products may include cosmetic goods, such as treatment products (e.g., anti-wrinkling cream, rejuvenating lotion, etc.), personal cleansing products, and makeup products, in any form (e.g., ointments, creams, gels, sprays, supplements, ingesta, inhalants, lotions, cakes, liquids, and powders). Examples of services may include hair styling, hair cutting, hair coloring, hair removal, beauty treatments, skin treatment, make-up application, and any other offering for aesthetic enhancement. Further, services may include massages, facial rubs, deep cleansings, applications of beauty product, exercise, therapy, or any other action affecting the body or face whether performed by a professional, the individual, or an acquaintance of the individual. Examples of care routines may include a beauty care regimen specifying a schedule, a time, a frequency, and/or a manner in which the individual should use certain services and products, or take certain beauty-related actions.

The following is an exemplary and non-exhaustive list of a few products: scrubs, rinses, washes, moisturizers, lotions, creams, wrinkle removers, exfoliates, toners, cleansers, conditioners, soaps, shampoos, sprays, cuticle creams, oils, anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products.

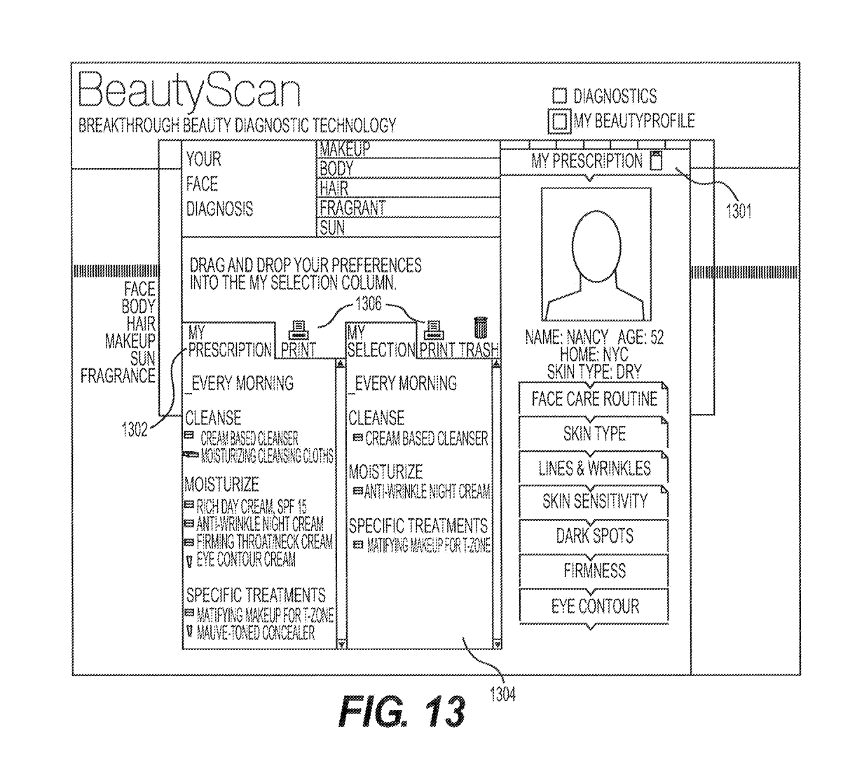

A prescription may address particular priority items and/or focus areas for the individual. In some examples, the prescription may be a generic prescription and the individual may be given the option to request a prescription with one or more specific products that match her brand preferences. For example, an individual may request her prescription by selecting “MY PRESCRIPTION” 1301 in FIG. 13, which may cause server 202 to provide a generic prescription 1302 according to the individual's sub-topic, topic, and/or overall diagnoses (partially or fully completed). Generic prescription 1302 may include recommendations relating to when and how often the individual could use prescribed services and products. The individual may customize the generic prescription by clicking and dragging items from a “My Prescription” column 1302 to a “My Selection” column 1304. She may print generic prescription 1302 and/or personalized prescription 1304 by selecting “Print” 1306. In the example of FIG. 13, prescription 1302 is generic in the sense that it lists one or more general types and/or categories of products rather than referring to either products of a particular brand or products sold at a particular venue.

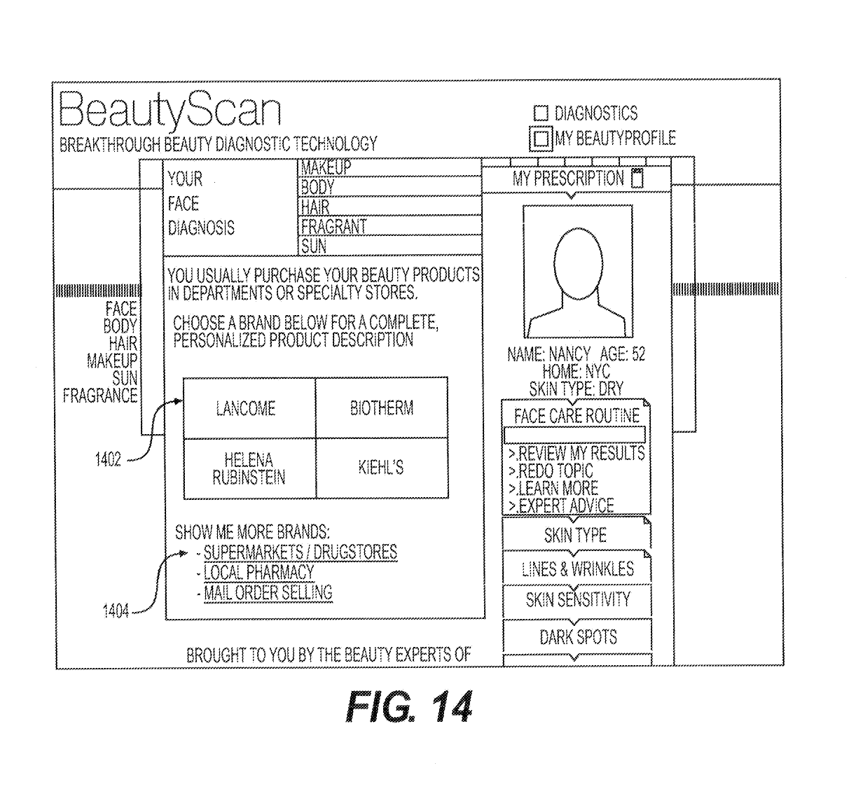

As illustrated in FIG. 14, if the individual desires a prescription incorporating the use of specific products that match her brand and/or venue preferences, then she may indicate her brand preference 1402 (e.g., LANCOME products, BIOTHERM products, HELENA RUBINSTEIN products, KIEHL'S products, etc.) and/or preferred shopping venues 1404 (e.g., supermarkets, drugstores, local pharmacy, mail order, spa, salon, etc.).

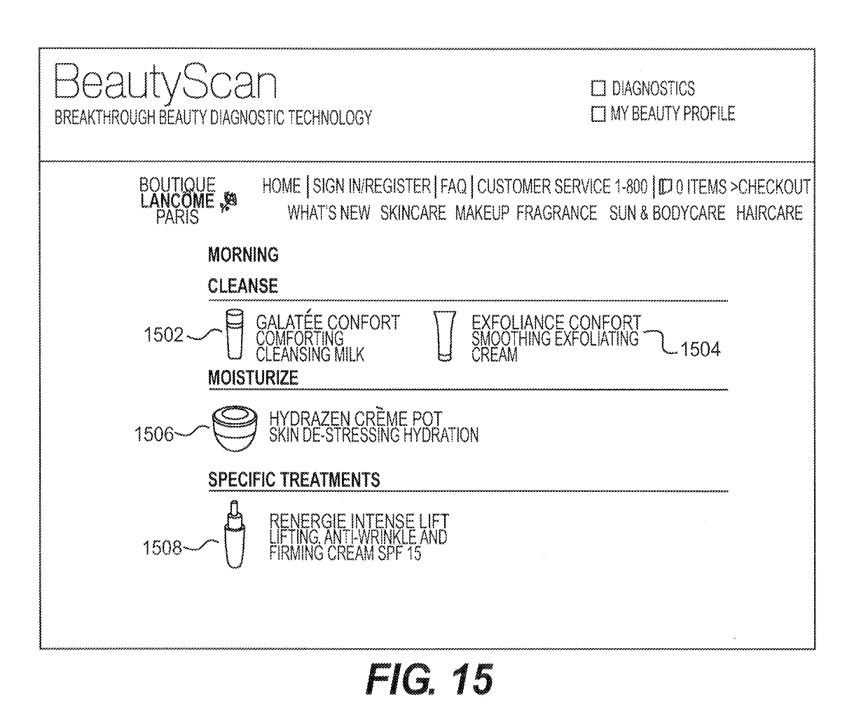

Server 202 may provide brand-specific service and/or product recommendations to the individual according to her indicated brand preference. For example, as illustrated in FIG. 15, if the individual indicates that she prefers LANCOME services and products, then server 202 may present a prescription using LANCOME services and products (e.g., LANCOME cleansing milk 1502, LANCOME exfoliating cream 1504, LANCOME hydrating cream 1506, and LANCOME anti-wrinkle cream 1508) matching generic prescription 1302, her personalized prescription 1304, and/or portions thereof. Optionally, the method may include offering one or more products and/or services (e.g., the prescribed products and/or services) for sale, enabling an individual to purchase those products/services, and/or enabling an individual to obtain further information about them.

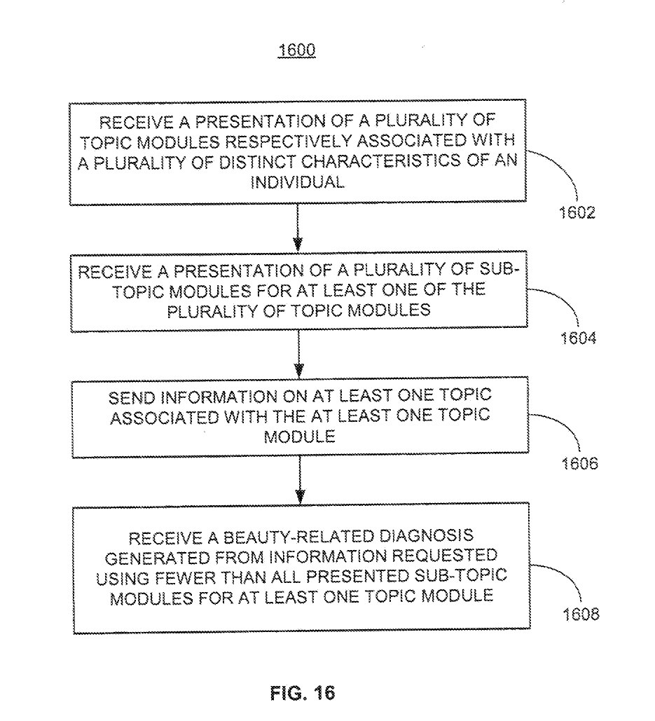

The above description explains how server 202 may generate a beauty-related diagnosis via exemplary method 400 (FIG. 4). According to features and principles of the present invention, a client station 204 may generate a beauty-related diagnosis via exemplary method 1600 (FIG. 16). Client station 204 may receive a presentation of a plurality of topic modules respectively associated with a plurality of distinct characteristics of an individual (step 1602) and a presentation of a plurality of sub-topic modules for at least one of the plurality of topic modules (step 1604). Client station 204 may send information on at least one topic associated with the at least one topic module (step 1606). The sent information may comprise information requested using fewer than all of the presented sub-topic modules for the at least one topic module. Client station 204 may receive a beauty-related diagnosis generated from the information requested using fewer than all of the presented sub-topic modules for the at least one topic module (step 1608).

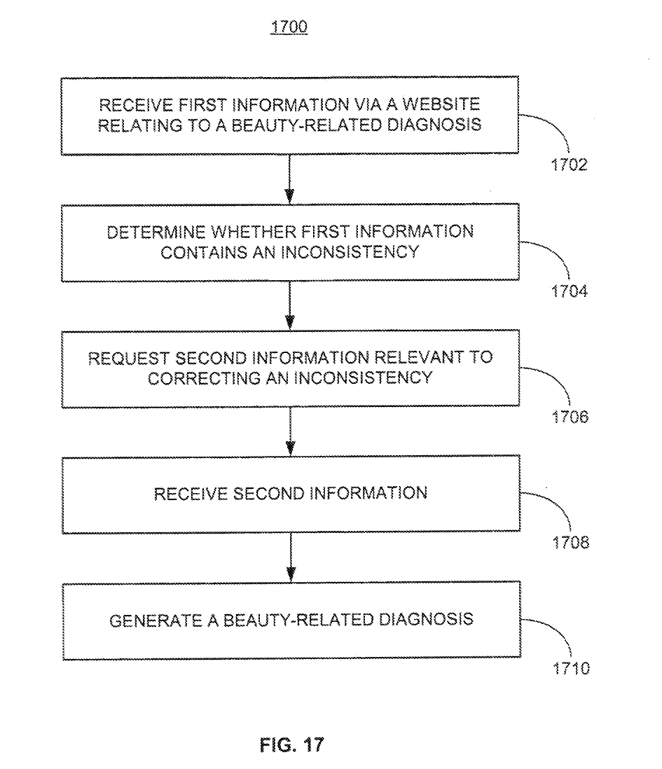

As previously discussed, server 202 may receive information from an individual (e.g., steps 404 and/or 410 in FIG. 4) to generate a beauty-related diagnostic. According to features and principles of the present invention, server 202 may check the received information for one or more inconsistencies according to a method 1700, as illustrated in FIG. 17. Server 202 may receive first information via a website relating to a beauty-related diagnosis (step 1702), determine whether the first information contains an inconsistency (step 1704), request second information relevant to correcting an inconsistency (step 1706), receive the second information (step 1708), and generate the beauty-related diagnosis (step 1710). Server 202 may use the second information to generate the beauty-related diagnosis only if the second information does not contain an inconsistency. Alternatively, server 202 may use the second information even if it contains an inconsistency.

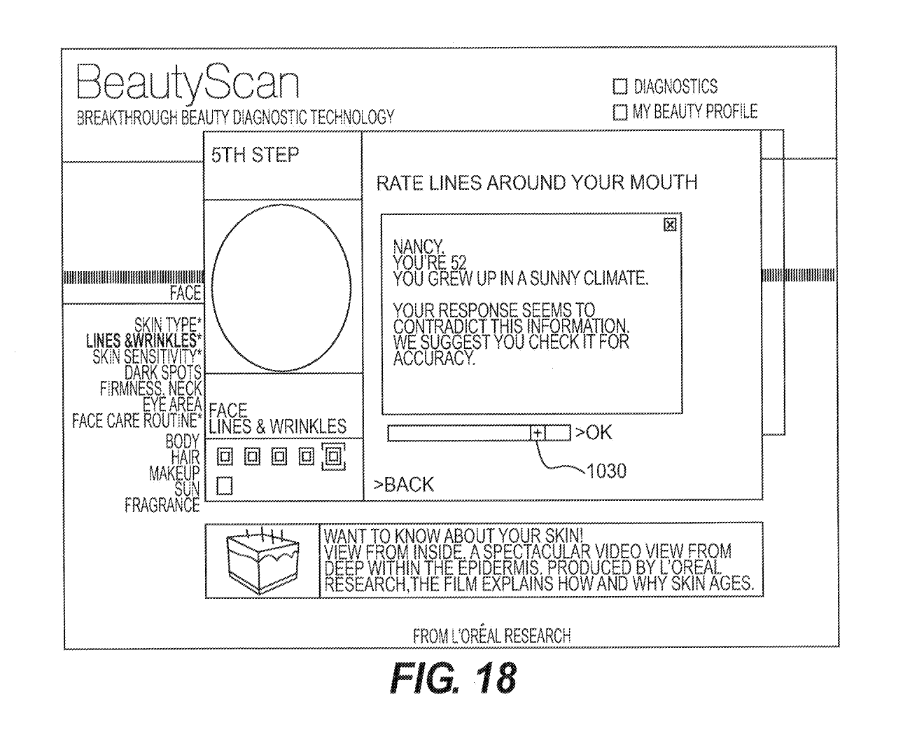

For example, as illustrated in FIG. 18, if server 202 receives information from an individual indicating that she is 52 years old and grew up in a sunny client, but has very few wrinkles (e.g., first information), then server 202 may request additional information from the individual. If the individual continues to provide inconsistent information (e.g., she provides additional information continuing to indicate that she has very few wrinkles despite being 52 years old and growing up in a sunny climate), then server 202 may choose to ignore the inconsistent information or use the inconsistent information when generating a beauty-related diagnosis for the individual.

If the server 202 determines that both the first and second information contain an inconsistency, server 202 may select consistent information and generate the beauty-related diagnosis using the consistent information in place of the first information containing an inconsistency and the second information containing an inconsistency. Server 202 may select the consistent information using a neural network and/or average consistent information (e.g., an average of typical answers from other individuals who are 52 years old and grew up in a sunny climate).

Server 202 may determine whether the first or second information contains an inconsistency by determining whether the first or second information contains an inconsistency with respect to previously received information (e.g., an answer to a prior question), and verifying whether the previously received information is correct when the first or second information contains an inconsistency. Server 202 may verify the previously received information by presenting a previously presented question corresponding to the previously received information. For example, in FIG. 18, server 202 may ask the individual to verify her age and the climate she grew up in. Her age and climate are previously received personal and lifestyle information in FIGS. 6A and 7A, respectively.

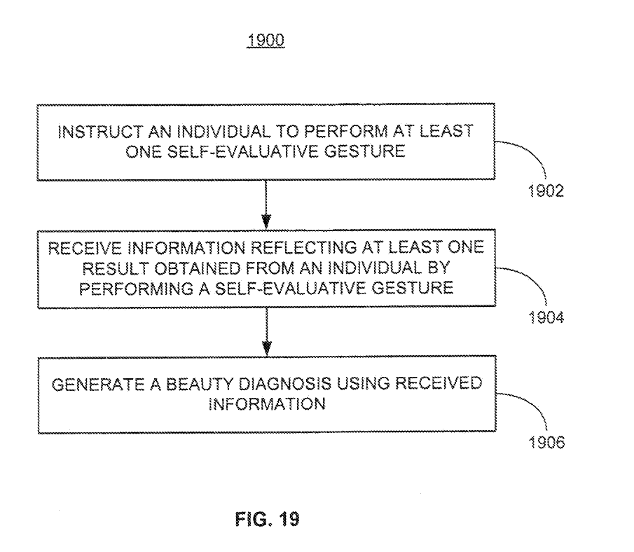

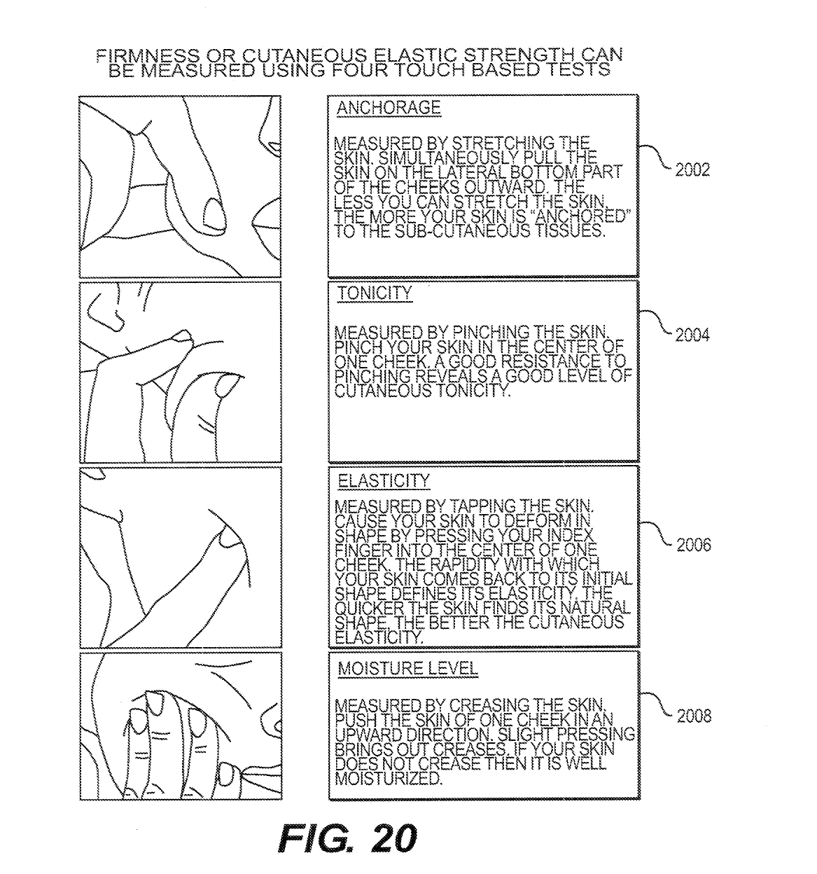

As discussed above in connection with FIGS. 8 and 9, face module 802 may include a firmness module 916 to generate a firmness sub-topic diagnosis. Firmness module 916 (and/or one or more other modules) may use evaluative gestures to generate the sub-topic diagnosis. For example, server 202 may generate the firmness sub-topic diagnosis according to exemplary method 1900 illustrated in FIG. 19. In method 1900, server 202 may instruct an individual to perform at least one self-evaluative gesture (step 1902), and may receive information reflecting at least one result obtained from the individual by performing the self-evaluative gesture (step 1904). As illustrated in FIG. 20, an evaluative gesture may include gestures for evaluating the individual's skin anchorage 2002, tonicity 2004, elasticity 2006, moisture level 2008, or any other skin characteristic. A self-evaluative gesture may include evaluative gestures performed by an individual on herself.

For example, gestures for evaluating anchorage 2002 may include stretching an individual's skin by pulling the lateral bottom part of the cheeks outward. The less the skin stretches, the more “anchored” the skin may be to sub-cutaneous tissues. Gestures for evaluating tonicity 2004 may include pinching the individual's skin in the center of her cheek. A good resistance to pinching may reveal a good level of cutaneous tonicity. Gestures for evaluating elasticity 2006 may include tapping the skin of the individual's cheek by pressing an index finger into the center of the cheek. The quicker the skin returns to its natural shape, the better its cutaneous elasticity. Gestures for evaluating moisture level 2008 may include creasing the individual's skin by pushing the skin of one cheek in an upwards direction. If the skin does not crease then it may be well moisturized.

According to features and principles of the present invention, server 202 may generate a beauty diagnosis (step 1906) using at least information received from step 1904. The beauty diagnosis may include an overall diagnosis, a topic diagnosis (e.g., for face module 802 in FIG. 8), and/or a sub-topic diagnosis (e.g., for firmness module 916 in FIG. 9). For example, server 202 may request that an individual evaluate her skin anchorage by performing an anchorage self-evaluative gesture 2002. After receiving the results of the anchorage self-evaluative gesture 2002, server 202 may provide a firmness diagnosis. Additionally or alternatively, server 202 may instruct the individual to perform a plurality of differing self-evaluative gestures. Server 202 may receive first information reflecting at least one result obtained from the individual by performing at least one of the self-evaluative gestures and receive second information reflecting at least one result obtained from the individual by performing at least another self-evaluative gesture. Server 202 may generate a beauty diagnosis by determining a weighted average of at least the first information and the second information.

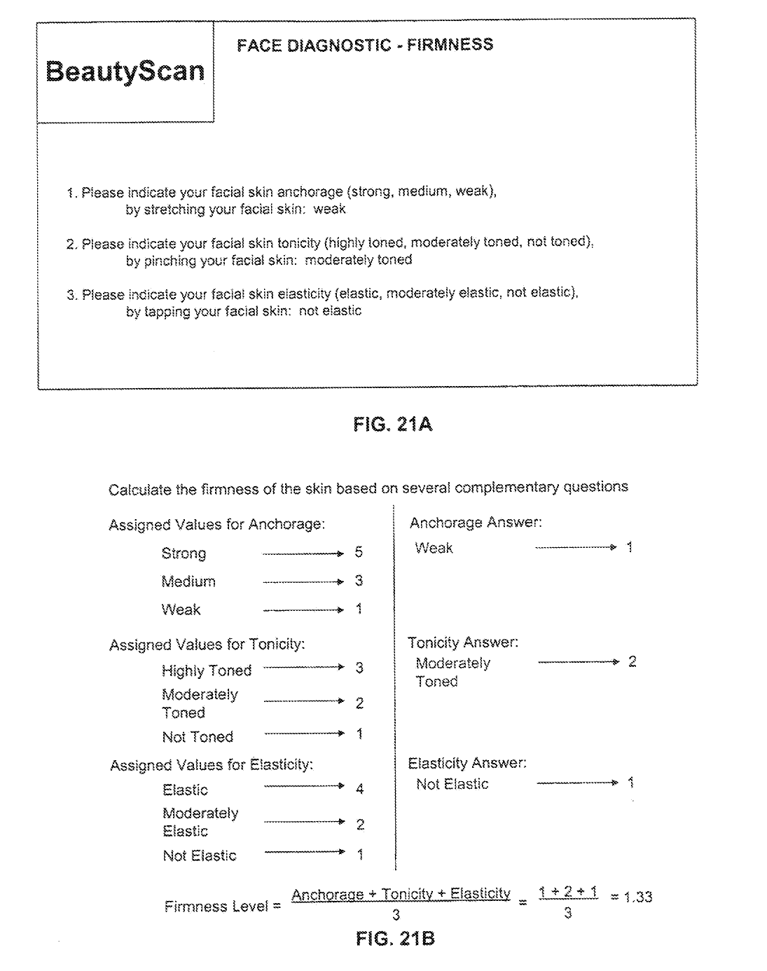

For example, FIG. 21A illustrates exemplary requests by server 202 for an individual to perform several different self-evaluative gestures and to provide information resulting from the self-evaluative gestures. Server 202 may request a user to indicate her facial skin anchorage, tonicity, and elasticity using evaluative gestures illustrated in FIG. 20. After server 202 receives the individual's answers (e.g., weak anchorage, moderately toned skin, and inelastic skin), it may assign values to the individual answers (e.g., weak anchorage=1, moderately toned skin=2, and inelastic skin=1), as illustrated in FIG. 21B. Server 202 may use the assigned values to generate a weighted average of the individual's answers and a corresponding firmness diagnosis, which in this example, may comprise a firmness level of 1.33.

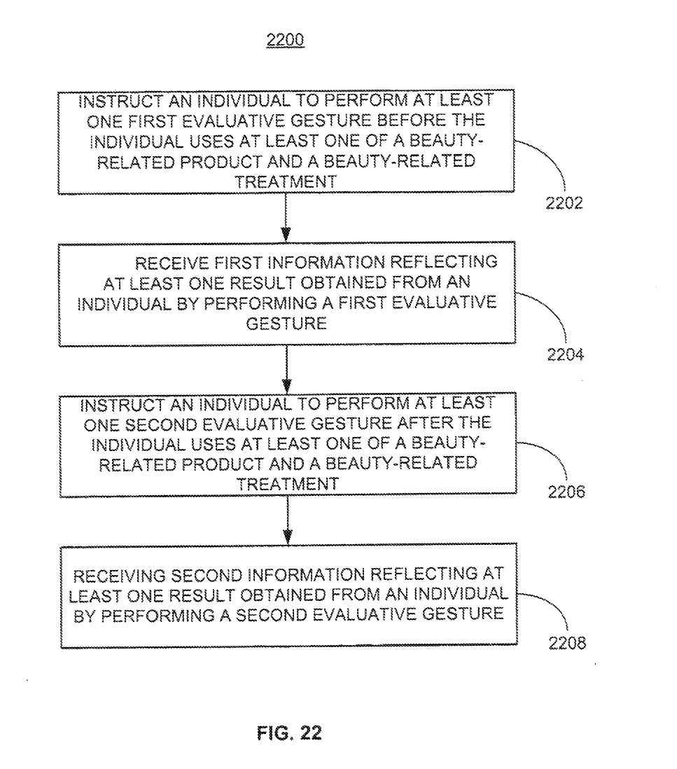

According to features and principles of the present invention, gestures may also be used to facilitate evaluation of at least one of a beauty-related product and a beauty-related treatment, as illustrated by method 2200 in FIG. 22. Method 2200 may comprise instructing an individual to perform at least one first evaluative gesture before the individual uses at least one of a beauty-related product and a beauty-related treatment (step 2202), receiving first information reflecting at least one result obtained from the individual by performing the first evaluative gesture (step 2204), instructing the individual to perform at least one second evaluative gesture after the individual uses at least one of the beauty-related product and the beauty-related treatment (step 2206), and receiving second information reflecting at least one result obtained by the individual by performing the second evaluative gesture (2208). The first information and the second information may be used to evaluate at least one of the beauty-related product and the beauty-related treatment.

For example, server 202 (FIG. 2) may instruct an individual or another party (e.g., cosmetician, beauty assistant, etc.) to measure the individual's skin anchorage 2002 (FIG. 2) by performing an anchorage evaluative gesture 2002 (FIG. 20) and may receive information reflecting the anchorage of the individual's skin. The individual may then use a product or treatment, such as an anti-wrinkling cream. After the individual uses the product or treatment, server 202 may instruct the individual to perform a second anchorage evaluative gesture and receive additional information reflecting the anchorage of the individual's skin. The second anchorage evaluative gesture may be the same as the first anchorage evaluative gesture or may be another type of anchorage evaluative gesture. Server 202 may evaluate the effectiveness of the anti-wrinkling cream by comparing the information reflecting the anchorage of the individual's skin before and after using the anti-wrinkling cream.

In the above example, server 202 provides instructions for performing evaluative gestures and receives information reflecting their results. However, as one of ordinary skill in the art will appreciate, other actors (e.g., client station 204 in FIG. 2, a cosmetic assistant, a sales person, a research scientist, etc.) or combinations of actors may also provide instructions for performing evaluative gestures and receive information reflecting their results in a similar manner.

According to features and principles of the present invention, information relating to an individual's beauty care routine may be collected using an environment presented on a computer, such as system 300 in FIG. 3 (e.g., an environment displayed on display 308 shown in FIG. 3). The environment may include a virtual environment (e.g., a virtual bathroom, a virtual bedroom, a virtual spa, a virtual salon, etc.) or an image (e.g., digital picture, screen still, etc.) of a real world location (e.g., an actual bathroom, bedroom, spa, salon, etc.). The collected information may include types of beauty-related products and beauty-related services that the individual uses, how often she uses them, and/or when she uses them. The individual may provide the collected information by interacting with the environment to specify the products that she uses and a beauty-related diagnosis may be generated for her using the collected information.

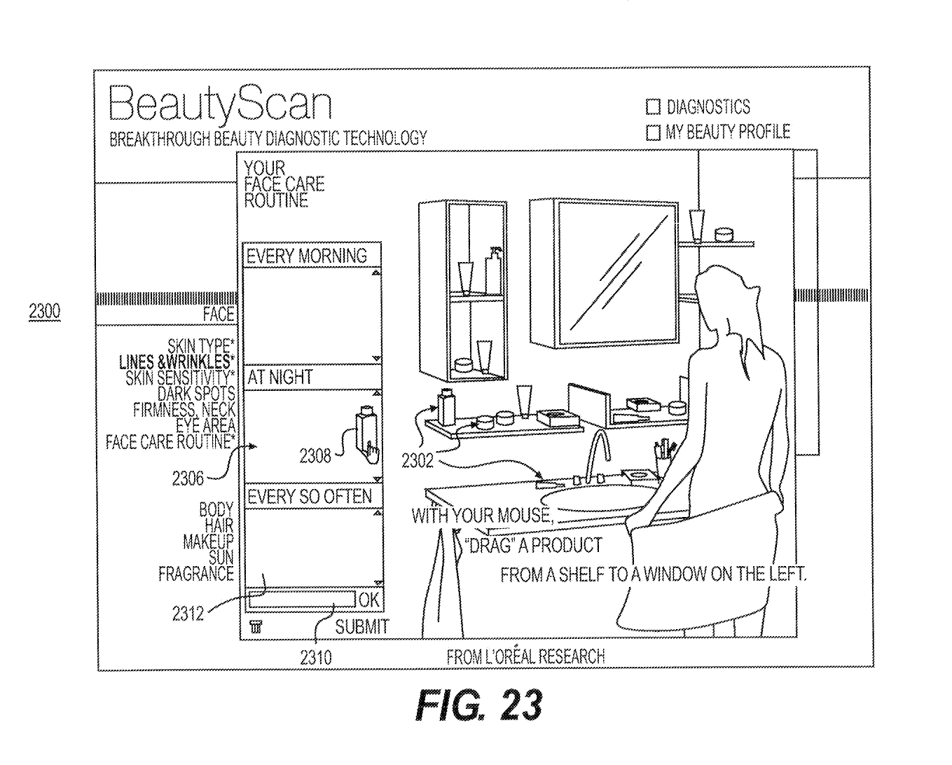

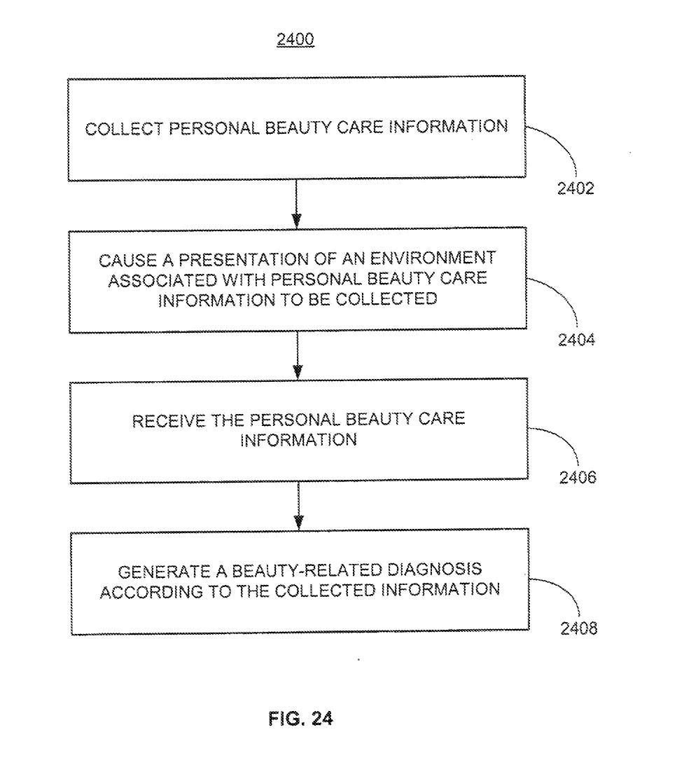

For example, as part of a face care routine module 912 (FIG. 9) in face module 802 (FIGS. 8 and 9), server 202 (FIG. 2) may present a virtual bathroom 2300 (FIG. 23) to an individual via client station 204. Server 202 may use virtual bathroom 2300 to collect personal beauty care information from the individual to generate a beauty-related diagnosis from the collected information. The individual may provide personal beauty care information by selecting, from a display space 2304, objects 2302 that represent products that she uses and dragging the selected object to a beauty care input area 2306. Server 202 may determine, for example, when and how often the individual uses a product according to where she places an object 2308 in beauty care input area 2306 (e.g., every morning, at night, and/or every so often, as illustrated in FIG. 23). Server 202 may collect personal beauty care information (step 2402) by causing a presentation of an environment associated with collecting the personal beauty care information (step 2404) and receiving the personal beauty care information (step 2406), as illustrated by exemplary method 2400 of FIG. 24.

An individual may manipulate objects 2302 in the environment using an I/O device (e.g., mouse, keyboard, trackball, etc.) on client station 204 (FIG. 2) (e.g., using I/O device 306 of FIG. 3). Objects 2302 may be virtual objects and/or facsimiles of products and services typically found in a location corresponding to the environment. The environment may include facsimiles and/or virtual representations of other items typically found in the location to provide atmosphere to the environment and/or better simulate the location.

For example, if the environment is a virtual bathroom, as shown in FIG. 23, then server 202 may present virtual representations and/or facsimiles of a bathroom mirror, a bathroom cabinet (e.g., medicine cabinet and/or cupboard), a bathroom shelf, a bathroom sink, a bag or other container containing beauty-related items, a drawer, a bath tub, a shower, a toilet, and/or any other appropriate item in the virtual bathroom. The environment may include typical virtual objects and/or facsimiles of products and services at appropriate locations in the environment. If the environment does not list or include a specific product or service used by an individual, the individual may enter the product or service's name at text box 2310 and server 202 may create and display a virtual object and/or facsimile representing the named product or service on display area 2304.

Personal beauty care information received at step 2406 of FIG. 24 may comprise a time of usage, a schedule of usage, and/or a frequency of usage of a product or a service by the individual. The time of usage may include particular or approximate times (e.g., morning, afternoon, evening, 6 am, 6 pm, etc.) of when the individual uses the product and/or service. The schedule of usage may include a day (e.g., Monday, Tuesday, weekday, weekend), date (e.g., first of every month, etc.), etc. that the individual uses the product and/or service. The frequency of usage may include how often (e.g., every morning, everyday, every week, every month, every so often, etc.) the individual uses the product and/or service.

Personal beauty care information may comprise a beauty care regimen, such as a bathroom regimen, a bedroom regimen, a salon regimen, and/or a spa regimen. Server 202 may receive an individual's beauty care regimen from the personal beauty care information provided by her as she places virtual objects and/or facsimiles of products and services into beauty care input area 2310. For example, if an individual places a moisturizer in “Every so often” window 2312, then server 202 may receive information indicating that the individual uses a moisturizer every so often.

An individual may provide personal beauty care information to server 202 by manipulating an object 2302 in the environment in a variety of different ways. The individual may click, drag, point to, and/or select the object, and/or use any other mechanism compatible with features and principles of the present invention.

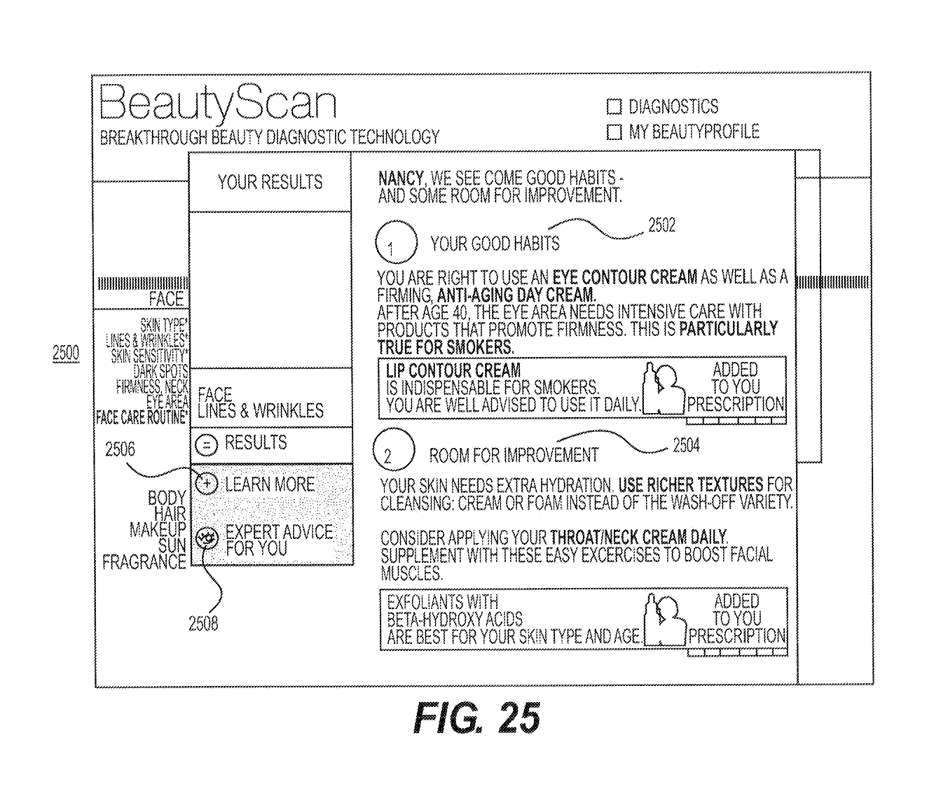

Consistent with features and principles of the present invention, server 202 may generate a beauty-related diagnosis according to collected information (step 2408 of FIG. 24). Server 202 may generate the beauty-related diagnosis in a manner previously described herein or in any other manner. For example, if server 202 is performing a sub-topic diagnostic (e.g., face care routine module 912 of FIG. 9), then server 202 may generate a sub-topic diagnosis (e.g., face care routine diagnosis) using personal beauty care information received at steps 2402-2406 of FIG. 24. Server 202 may then use the sub-topic diagnosis to generate a topic diagnosis, which in turn may be used to generate an overall diagnosis, as previously discussed. FIG. 25 illustrates an exemplary sub-topic diagnosis 2500 that may be generated using face care routine module 912 after an individual uses virtual bathroom 2300 of FIG. 23 to supply server 202 with an identification of the products and services she uses and when she uses them.

Exemplary sub-topic diagnosis 2500 indicates that the individual has good habits/practices 2502 and should continue to use eye contour cream and anti-wrinkle cream in her face care routine because after age 40, the eye area needs intensive care with products that promote firmness, especially for smokers. Sub-topic diagnosis 2500 also indicates that the individual has bad habits/practices 2504 and has room for improvement (e.g., she should use cleansers with richer textures, throat/neck cream, facial exercises, etc.). Similar to sub-topic diagnosis 1100 for an individual's wrinkles in FIG. 11A, server 202 offers the individual an option to “LEARN MORE” 2506 or obtain “EXPERT ADVICE” 2508 regarding sub-topic diagnosis 2500 for her face care routine.

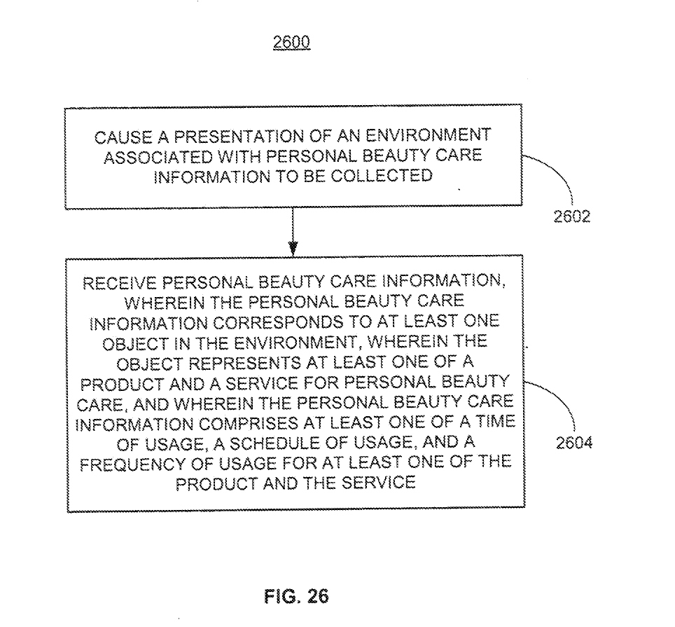

According to features and principles of the present invention, server 202 may perform a method 2600 for collecting personal beauty care information, as illustrated in FIG. 26. Server 202 may cause a presentation of an environment associated with personal beauty care information to be collected (step 2602), and may receive the personal beauty care information (2604). The personal beauty care information may correspond to at least one object in the environment and may comprise at least one of a time of usage, a schedule of usage, and a frequency of usage for at least one of the product and the service. The object may represent at least one of a product and a service for personal beauty care.

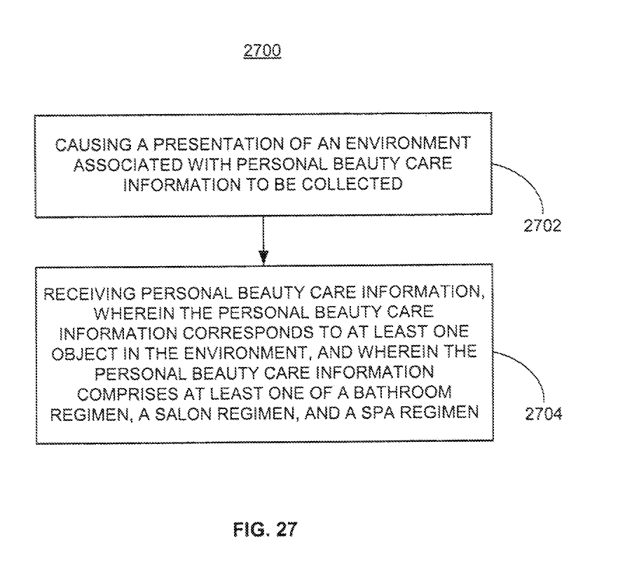

According to features and principles of the present invention, server 202 may perform a method 2700 for collecting personal beauty care information, as illustrated in FIG. 27. Server 202 may cause a presentation of an environment associated with personal beauty care information to be collected (step 2702), and may receive the personal beauty care information (step 2704). The personal beauty care information may correspond to at least one object in the environment and may comprise at least one of a bathroom regimen, a salon regimen, and a spa regimen.

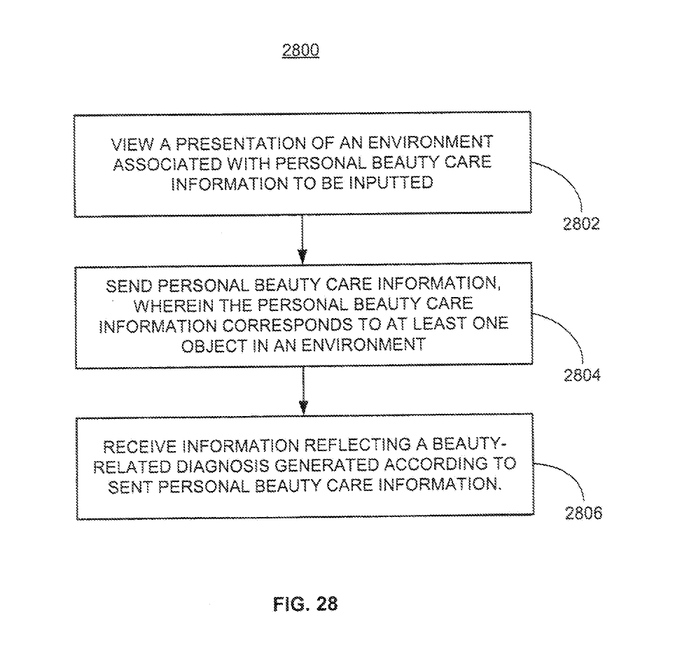

According to features and principles of the present invention, client station 204 (FIG. 2) may enable an individual to perform a method 2800 of providing a beauty-related diagnosis, as illustrated in FIG. 28. Client station 204 may enable the individual to view a presentation of an environment associated with personal beauty care information to be inputted (step 2802), to send the personal beauty care information (step 2804), and to receive information reflecting a beauty-related diagnosis generated according to the sent personal beauty care information (step 2806).

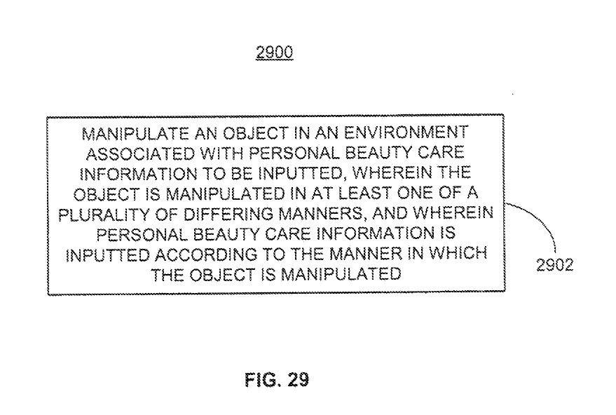

According to features and principles of the present invention, client station 204 may enable an individual to perform a method 2900 of providing personal beauty care information, as illustrated in FIG. 29. Client station 204 may enable the individual to manipulate an object in an environment associated with personal beauty care information to be inputted (step 2902). Client station 204 may also enable the individual to manipulate the object in at least one of a plurality of differing manners. The personal beauty care information may be inputted according to the manner in which the object is manipulated. For example, in virtual bathroom 2300 of FIG. 23, information concerning product and/or service usage is inputted according to where an individual places an object 2302 in beauty care input area 2306. Numerous alternative arrangements are possible.

As mentioned above with reference to FIGS. 1A and 1B, an individual may access diagnostic engine 102 via web pages 100 and 150, which may be portal websites and/or websites generic to differing brands of services and/or products. However, diagnostic engine 102 may also be accessible via brand-specific websites. That is, the same diagnostic engine 102 described above may provide beauty-related diagnostics via a generic website and a brand-specific website. Further, although diagnostic engine 102 may be the same on either generic or brand-specific websites, it may assume that an individual accessing diagnostic engine 102 via a brand-specific website will wish to use products and services of the same brand as the brand-specific website. Hence, at the brand-specific website, diagnostic engine 102 may only prescribe and/or offer to sell products and services that are of the same brand as the brand-specific website.

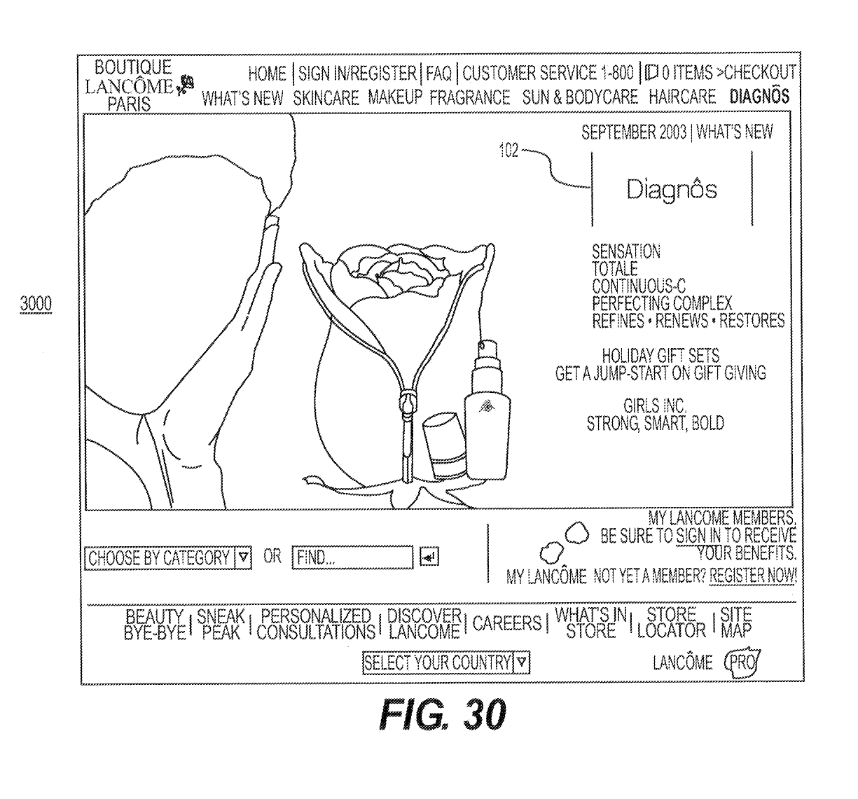

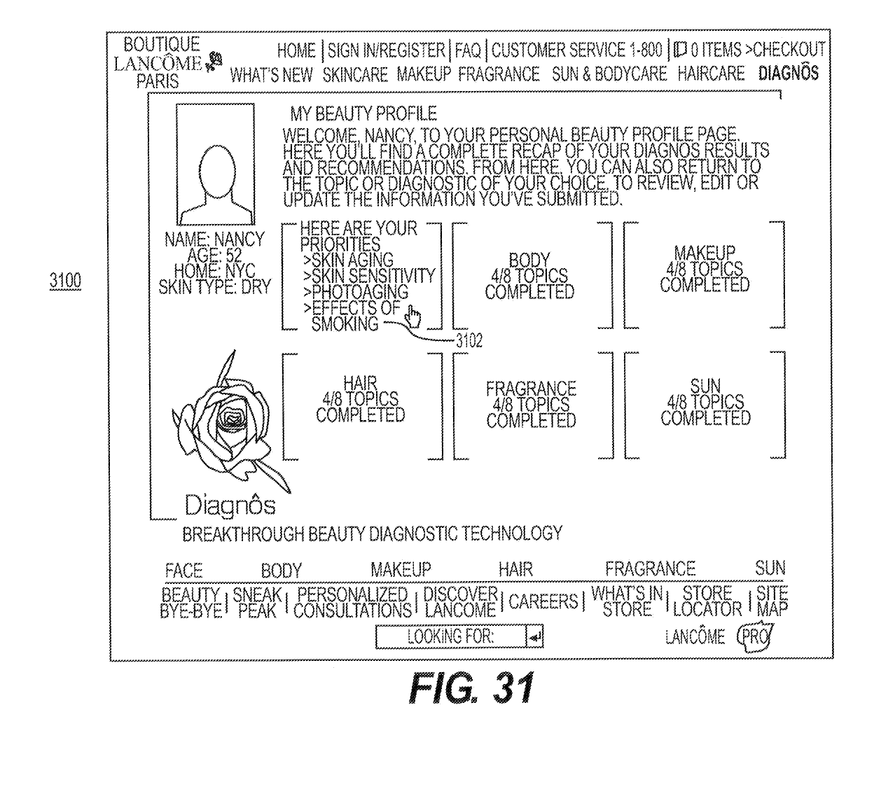

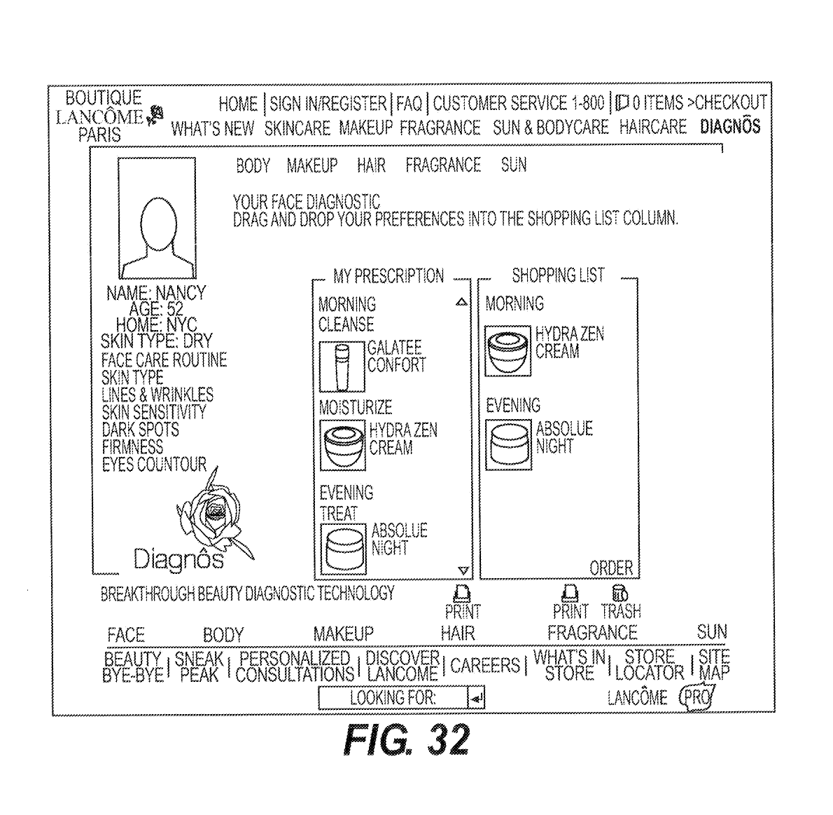

For example, FIG. 30 shows a brand-specific website 3000 (e.g., LANCOME) with diagnostic engine 102. An individual may access diagnostic engine 102 by selecting the Diagnos block on website 3000 and be presented with her beauty profile generated when she accessed diagnostic engine 102 at generic website 100 or 150 (FIGS. 1A and 1B). However, as shown in FIG. 31, when she accesses her face diagnosis 3102 at web page 3100 of the brand-specific website, she is presented with a prescription, shown in FIG. 32, having only brand-specific products and services (e.g., LANCOME products and services), which may be purchased by the her at that time.

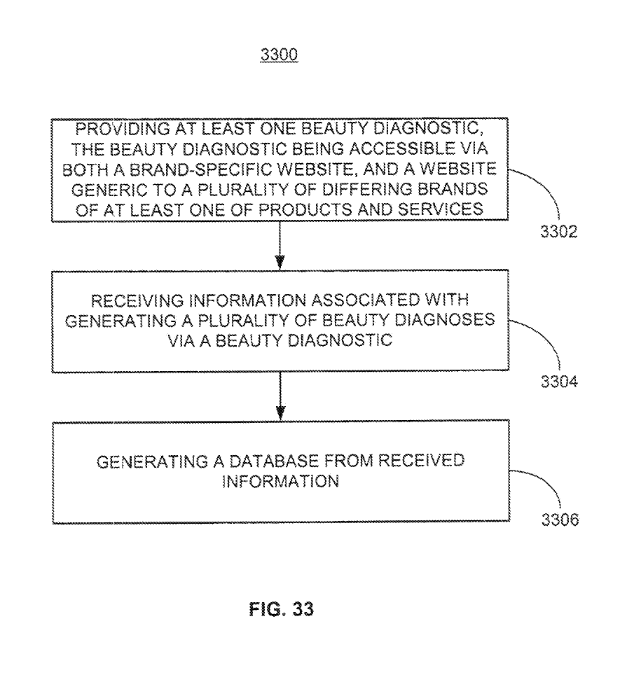

According to features and principles of the present invention, server 202 (FIG. 2) may facilitate access to a beauty diagnostic according to a method 3300 illustrated in FIG. 33. Server 202 may provide a beauty diagnostic accessible via both a brand-specific website and a website generic to a plurality of differing brands of products and/or services (step 3302). The beauty diagnostic may include any beauty-related diagnostic described herein. A website generic to a plurality of differing brands of products and/or services (i.e., generic website) may include a portal website and/or any website not exclusively associated with a single specific brand of product and/or service. Exemplary generic websites may include websites for YaHoo, American Online, Microsoft Network, L'OREAL, etc. For example, the Microsoft Network website may be considered generic in the sense that it may not be specifically affiliated with only a single brand of beauty-related products and services, and the L'OREAL website may be considered generic in the sense that it may be affiliated with many differing brands, such as BIOTHERM, CACHAREL, CCB, GARNIER, GIORGIO ARMANI, HELENA RUBINSTEIN, KERASTASE, KIEHL'S, LANCOME, L'OREAL PARIS, L'OREAL PROFESSIONAL, MATRIX, MAYBELLINE, OMBRELLE, RALPH LAUREN, REDKEN, SHU UEMURA, SOFTSHEEN-CARSON, VICHY, etc.

A brand-specific website may include any website exclusively or almost exclusively associated with one single brand. Exemplary brand-specific websites may include websites of BIOTHERM, CACHAREL, CCB, GARNIER, GIORGIO ARMANI, HELENA RUBINSTEIN, KERASTASE, KIEHL'S, LANCOME, L'OREAL PARIS, L'OREAL PROFESSIONAL, MATRIX, MAYBELLINE, OMBRELLE, RALPH LAUREN, REDKEN, SHU UEMURA, SOFTSHEEN-CARSON, VICHY, etc., and websites for other brands not necessarily affiliated with the exemplary generic L'OREAL website.

For example, server 202 may allow access to diagnostic engine 102 via both a generic website (e.g., websites 100 and 150) and a brand-specific website (e.g., website 3000). Server 202 may perform method 400 in FIG. 4 at websites 100, 150, and 3000, regardless of where and how an individual accesses diagnostic engine 102.

Providing at least one beauty diagnostic (step 3302) may include server 202 transmitting computer-readable instructions to at least a brand-specific website and/or a website generic to differing brands. The computer-readable instructions may be in any programming language and any form compatible to a computer. The computer-readable instructions may generate a beauty diagnosis according to the beauty diagnostic. Providing at least one beauty diagnostic (step 3302) may include server 202 transmitting a portion of diagnostic engine 102 to at least a brand-specific website and/or a website generic to differing brands. The transmitted portion may comprise computer-readable instructions causing at least a brand-specific website or a website generic to differing brands to request information from an individual to generate a beauty diagnosis, receive the requested information from the individual, generate the beauty diagnosis using diagnostic engine 102, and present information reflecting the generated beauty diagnosis to the individual.

According to features and principles of the present invention, server 202 may receive information associated with generating a plurality of beauty diagnoses via a beauty diagnostic (step 3304) and generate a database from the received information (step 3306), as illustrated in FIG. 33. The plurality of beauty diagnoses may be for a plurality of individuals. Any number of individuals may access diagnostic engine 102 from any website that incorporates diagnostic engine 102. Access to diagnostic engine 102 may be provided by a plurality of different websites using, for example, methods and systems described in U.S. patent application Ser. No. 10/024,352, filed on Dec. 21, 2001, which is incorporated herein by reference.

The database generated at step 3306 may comprise beauty-related diagnoses, beauty profiles, information supplied to generate the diagnoses and/or profiles, and/or other information for many individuals. As a result, the database may be used for research or marketing of beauty-related products and/or services.

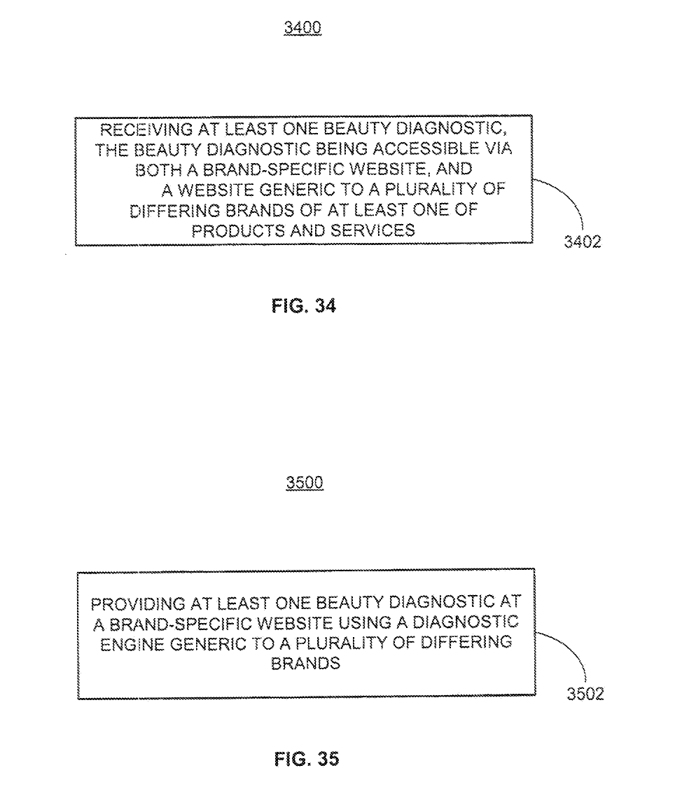

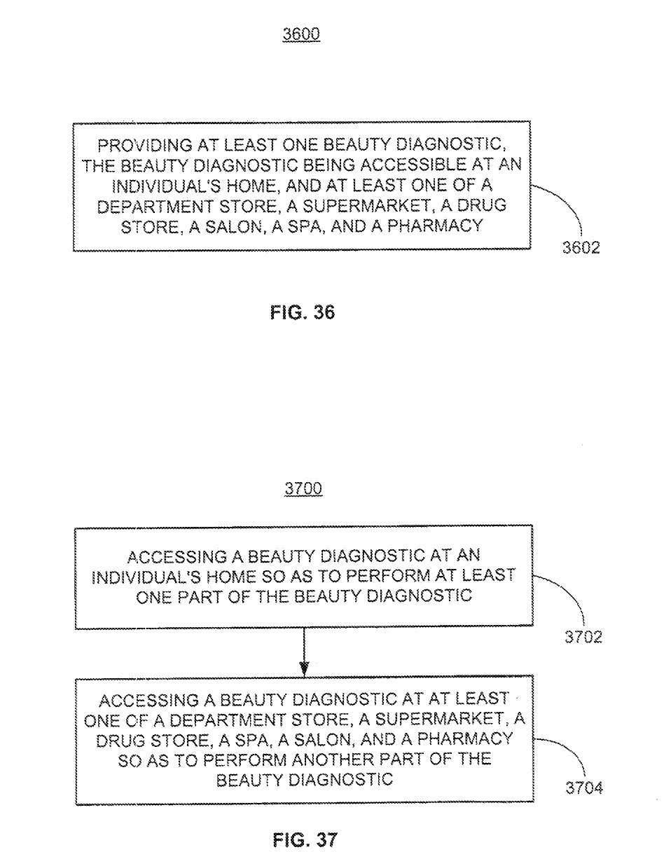

In parallel with server 202 performing method 3300, client station 204 may perform a method 3400 of facilitating access to a beauty diagnostic, as illustrated in FIG. 34. Client station 202 may receiving at least one beauty diagnostic (step 3302). The beauty diagnostic may be accessible via both a brand-specific website, and a website generic to a plurality of differing brands of at least one of products and services.

According to features and principles of the present invention, server 202 may perform a method 3500 of facilitating access to a beauty diagnostic, as illustrated in FIG. 35. Server 202 may provide at least one beauty diagnostic at a brand-specific website using a diagnostic-engine generic to a plurality of differing brands (step 3502).

According to features and principles of the present invention, server 202 may perform a method 3600 of facilitating access to a beauty diagnostic, as illustrated in FIG. 40. Server 202 may provide at least one beauty diagnostic (step 3602). The beauty diagnostic may be accessible at an individual's home, and also at a department store, a supermarket, a drug store, a salon, a spa, and/or a pharmacy. The beauty diagnostic may be accessible via a client station (e.g., a kiosk) at the department store, the supermarket, the drug store, the spa, the salon, and/or the pharmacy. Further, the information collected at the individual's home via the beauty diagnostic may be stored in a memory storage device (e.g., storage device 314 of FIG. 3 and/or a portable memory storage device) and may be available and/or used by the beauty diagnostic, when the beauty diagnostic is accessed outside of the individual's home (e.g., at the department store, a supermarket, a drug store, a salon, a spa, and/or a pharmacy).

In parallel with server 202 performing method 3600, one or more client stations 204 may enable an individual to perform a beauty diagnostic method 3700, as illustrated in FIG. 37. Client station(s) 204 may enable an individual to access a beauty diagnostic at an individual's home so as to perform at least one part of a beauty diagnostic (step 3702), and also enable the individual to access the beauty diagnostic at a department store, a supermarket, a drug store, a spa, a salon, and/or a pharmacy so as to perform another part of the beauty diagnostic (step 3704). For example, an individual may input some information associated with a diagnostic via a client station located at her home, and may input further diagnostic-related information via a client station located at a department store, a supermarket, a drug store, a spa, a salon, and/or a pharmacy, where there might be a beauty-related analysis device or service for performing a particular beauty-related analysis that may supply information used in the diagnostic.

One of ordinary skill in the art will appreciate that features and principles of the present invention may be implemented in a computer-readable medium (e.g., floppy disk, CD-ROM, storage device, etc.) containing instructions for a system, such as system 300, to execute the instructions. Further, one of ordinary skill in the art will appreciate that although the disclosure herein describes server 202 (FIG. 2) performing specific methods and operations, any portion of the methods and operations associated with server 202 may also be partially or completely performed by client station 204, and vice versa to achieve the same result. Also, it should be understood that although the disclosure herein generally uses female pronouns, features and principles of the present invention may apply to males, and/or both males and females.

The embodiments and aspects of the invention set forth above are only exemplary and explanatory. They are not restrictive of the invention as claimed. Other embodiments consistent with features and principles are included in the scope of the present invention.

In the foregoing description, various features are grouped together for purposes of streamlining the disclosure. This method of disclosure is not to be interpreted as reflecting an intention that the claimed invention requires more features than are expressly recited in each claim. Rather, as the following claims reflect, inventive aspects may lie in fewer than all features of a single foregoing disclosed embodiment.

1-41. (canceled)

42. A method of generating a beauty-related diagnosis for an individual, comprising:
collecting personal information of a user, including at least (1) first information including a physical attribute of the user's visual appearance and (2) second information including a beauty product used by the user and a timing of use of the product;
receiving the personal characteristics of the user;
generating, based on at least the first and second information, at least one recommended change to the beauty product and/or the timing of the use of the product;
sending a beauty-related diagnosis to the user, the beauty-related diagnosis including the at least one recommended change.

43. The method of claim 42, wherein the temporal characteristic is when the beauty product is used.

44. The method of claim 42, wherein the temporal characteristic is a schedule of when the beauty product is used.

45. The method of claim 42, wherein the at least one recommended change includes discontinuing use of the beauty product or changing the timing of use of the product.

46. The method of claim 42, wherein the at least one recommended change includes substituting the beauty product with another beauty product.

47. The method of claim 46, wherein the at least one recommended change includes providing a timing of the use of the another beauty product.

48. The method of claim 42, wherein the generating further comprises:
assessing, based on the physical attribute of the user's visual appearance in the first information, an impact of the beauty product and/or the timing of use of the product in the second information has on the user's visual appearance; and
determining, based on the assessing, whether the user's visual appearance can be improved by changes to the beauty product and/or timing of use of the product.

49. The method according to claim 42, wherein the physical attribute comprises at least one of a hair style, a hair color, a hair condition, a skin type, a skin condition, and/or a skin tone.

50. The method according to claim 42, wherein the generating does not utilize an image of the user.

51. The method of claim 42, further comprising between the receiving and the generating:
identifying, based on at least the first and/or second information, tests for the user;
sending the identified tests to the user; and
receiving the results of the tests,
wherein the generating is based on the results of the tests.

52. A method of generating a beauty-related diagnosis for an individual, comprising:
collecting personal information of a user, including at least (1) first information including a physical attribute of the user's visual appearance and (2) second information including an environmental characteristic of the user;
receiving the personal information of the user;
generating, from at least the first and second information, at least one recommended beauty product and a timing of the use of the beauty product;
sending a beauty-related diagnosis to the user, the beauty-related diagnosis including the beauty product and the timing of the use of the beauty product;
wherein the environmental characteristic defines an external environment of the user and/or actions taken by the user.

53. The method of claim 52, wherein the environmental characteristic includes current environmental characteristics of the user and/or past environmental characteristics of the user.

54. The method of claim 52, wherein the environmental characteristic includes employment, smoking habit, diet, drinking habit, sleeping habit, exercise habit, and/or sun exposure.

55. The method of claim 52, wherein the generating further comprises:
assessing, based on the physical attribute of the user's visual appearance in the first information and the environmental characteristic of the user in the second information, a beauty regiment specific to the user; and
the beauty diagnosis includes the beauty regiment.

56. The method according to claim 52, wherein the physical attribute comprises at least one of a hair style, a hair color, a hair condition, a skin type, a skin condition, and/or a skin tone.

57. The method according to claim 52, wherein the generating does not utilize an image of the user.

58. The method of claim 52, further comprising between the receiving and the generating:
identifying, based on at least the first and/or second information, tests for the user;
sending the identified tests to the user; and
receiving the results of the tests,
wherein the generating is based on the results of the tests.

59. A set of computer instructions on a non-transitory computer readable medium configured to generate a beauty-related diagnosis for an individual, the instructions comprising:
code for collecting personal information of a user, including at least (1) first information including a physical attribute of the user's visual appearance and (2) second information including a beauty product used by the user and a timing of use of the product;
code for receiving the personal characteristics of the user;
code for generating, based on at least the first and second information, at least one recommended change to the beauty product and/or the timing of the use of the product;
code for sending a beauty-related diagnosis to the user, the beauty-related diagnosis including the at least one recommended change.

60. The computer instructions of claim 59, wherein the temporal characteristic is when the beauty product is used.

61. The computer instructions of claim 59, wherein the temporal characteristic is a schedule of when the beauty product is used.

62. The computer instructions of claim 59, wherein the at least one recommended change includes discontinuing use of the beauty product or changing the timing of use of the product.

63. The computer instructions of claim 59, wherein the at least one recommended change includes substituting the beauty product with another beauty product.

64. The computer instructions of claim 63, wherein the at least one recommended change includes providing a timing of the use of the another beauty product.

65. The computer instructions of claim 59, wherein the code for generating further comprises:
code for assessing, based on the physical attribute of the user's visual appearance in the first information, an impact of the beauty product and/or the timing of use of the product in the second information has on the user's visual appearance; and
code for determining, based on the assessing, whether the user's visual appearance can be improved by changes to the beauty product and/or timing of use of the product.

66. The computer instructions according to claim 59, wherein the physical attribute comprises at least one of a hair style, a hair color, a hair condition, a skin type, a skin condition, and/or a skin tone.

67. The computer instructions according to claim 59, wherein the code for generating does not utilize an image of the user.

68. The computer instructions of claim 59, further comprising computer instructions configured to be executed between the steps executed by the code for receiving and the code for generating, the instructions comprising:
code for identifying, based on at least the first and/or second information, tests for the user;
code for sending the identified tests to the user; and
code for receiving the results of the tests,
wherein the generating is based on the results of the tests.

69. A set of computer instructions on a non-transitory computer readable medium configured to generate a beauty-related diagnosis for an individual, the instructions comprising:
code for collecting personal information of a user, including at least (1) first information including a physical attribute of the user's visual appearance and (2) second information including an environmental characteristic of the user;
code for receiving the personal information of the user;
code for generating, from at least the first and second information, at least one recommended beauty product and a timing of the use of the beauty product;
code for sending a beauty-related diagnosis to the user, the beauty-related diagnosis including the beauty product and the timing of the use of the beauty product;
wherein the environmental characteristic defines an external environment of the user and/or actions taken by the user.

70. The computer instructions of claim 69, wherein the environmental characteristic includes current environmental characteristics of the user and/or past environmental characteristics of the user.

71. The computer instructions of claim 69, wherein the environmental characteristic includes employment, smoking habit, diet, drinking habit, sleeping habit, exercise habit, and/or sun exposure.

72. The computer instructions of claim 69, wherein the code for generating further comprises:
code for assessing, based on the physical attribute of the user's visual appearance in the first information and the environmental characteristic of the user in the second information, a beauty regiment specific to the user; and
the beauty diagnosis includes the beauty regiment.

73. The computer instructions according to claim 69, wherein the physical attribute comprises at least one of a hair style, a hair color, a hair condition, a skin type, a skin condition, and/or a skin tone.

74. The computer instructions according to claim 69, wherein the code for generating does not utilize an image of the user.

75. The computer instructions of claim 69, further comprising further comprising computer instructions configured to be executed between the steps executed by the means for receiving and the means for generating, the instructions comprising:
code for identifying, based on at least the first and/or second information, tests for the user;
code for sending the identified tests to the user; and
code for receiving the results of the tests,
wherein the generating is based on the results of the tests.

76. A system configured to generate a beauty-related diagnosis for an individual, the system comprising:
means for collecting personal information of a user, including at least (1) first information including a physical attribute of the user's visual appearance and (2) second information including a beauty product used by the user and a timing of use of the product;
means for receiving the personal characteristics of the user;
means for generating, based on at least the first and second information, at least one recommended change to the beauty product and/or the timing of the use of the product;
means for sending a beauty-related diagnosis to the user, the beauty-related diagnosis including the at least one recommended change.

77. The system of claim 76, wherein the temporal characteristic is when the beauty product is used.

78. The system of claim 76, wherein the temporal characteristic is a schedule of when the beauty product is used.

79. The system of claim 76, wherein the at least one recommended change includes discontinuing use of the beauty product or changing the timing of use of the product.

80. The system of claim 76, wherein the at least one recommended change includes substituting the beauty product with another beauty product.

81. The system of claim 80, wherein the at least one recommended change includes providing a timing of the use of the another beauty product.

82. The system of claim 76, wherein the means for generating further comprises:
means for assessing, based on the physical attribute of the user's visual appearance in the first information, an impact of the beauty product and/or the timing of use of the product in the second information has on the user's visual appearance; and
means for determining, based on the assessing, whether the user's visual appearance can be improved by changes to the beauty product and/or timing of use of the product.

83. The system according to claim 76, wherein the physical attribute comprises at least one of a hair style, a hair color, a hair condition, a skin type, a skin condition, and/or a skin tone.

84. The system according to claim 76, wherein the means for generating does not utilize an image of the user.

85. The system of claim 76, further comprising system configured to be executed between the steps executed by the means for receiving and the means for generating, the instructions comprising:
means for identifying, based on at least the first and/or second information, tests for the user;
means for sending the identified tests to the user; and
means for receiving the results of the tests,
wherein the generating is based on the results of the tests.

86. A system configured to generate a beauty-related diagnosis for an individual, the instructions comprising:
means for collecting personal information of a user, including at least (1) first information including a physical attribute of the user's visual appearance and (2) second information including an environmental characteristic of the user;
means for receiving the personal information of the user;
means for generating, from at least the first and second information, at least one recommended beauty product and a timing of the use of the beauty product;
means for sending a beauty-related diagnosis to the user, the beauty-related diagnosis including the beauty product and the timing of the use of the beauty product;
wherein the environmental characteristic defines an external environment of the user and/or actions taken by the user.

87. The system of claim 86, wherein the environmental characteristic includes current environmental characteristics of the user and/or past environmental characteristics of the user.

88. The system of claim 86, wherein the environmental characteristic includes employment, smoking habit, diet, drinking habit, sleeping habit, exercise habit, and/or sun exposure.

89. The system of claim 86, wherein the means for generating further comprises:
means for assessing, based on the physical attribute of the user's visual appearance in the first information and the environmental characteristic of the user in the second information, a beauty regiment specific to the user; and
the beauty diagnosis includes the beauty regiment.

90. The system according to claim 86, wherein the physical attribute comprises at least one of a hair style, a hair color, a hair condition, a skin type, a skin condition, and/or a skin tone.

91. The system according to claim 86, wherein the means for generating does not utilize an image of the user.

92. The system of claim 86, further comprising further comprising system configured to be executed between the steps executed by the means for receiving and the means for generating, the instructions comprising:
means for identifying, based on at least the first and/or second information, tests for the user;
means for sending the identified tests to the user; and
means for receiving the results of the tests,
wherein the generating is based on the results of the tests.

93. A system configured to generate a beauty-related diagnosis for an individual, comprising:
a computer module configured to collect personal information of a user, including at least (1) first information including a physical attribute of the user's visual appearance and (2) second information including a beauty product used by the user and a timing of use of the product;
a computer module configured to receive the personal characteristics of the user;
a computer module configured to generate, based on at least the first and second information, at least one recommended change to the beauty product and/or the timing of the use of the product;
a computer module configured to send a beauty-related diagnosis to the user, the beauty-related diagnosis including the at least one recommended change.

94. The system of claim 93, wherein the temporal characteristic is when the beauty product is used.

95. The system of claim 93, wherein the temporal characteristic is a schedule of when the beauty product is used.

96. The system of claim 93, wherein the at least one recommended change includes discontinuing use of the beauty product or changing the timing of use of the product.

97. The system of claim 93, wherein the at least one recommended change includes substituting the beauty product with another beauty product.

98. The system of claim 97, wherein the at least one recommended change includes providing a timing of the use of the another beauty product.

99. The system of claim 93, wherein the a computer module configured to generate further comprises:
a computer module configured to assess, based on the physical attribute of the user's visual appearance in the first information, an impact of the beauty product and/or the timing of use of the product in the second information has on the user's visual appearance; and
a computer module configured to determine, based on the assessing, whether the user's visual appearance can be improved by changes to the beauty product and/or timing of use of the product.

100. The system according to claim 93, wherein the physical attribute comprises at least one of a hair style, a hair color, a hair condition, a skin type, a skin condition, and/or a skin tone.

101. The system according to claim 93, wherein the a computer module configured to generate does not utilize an image of the user.

102. The system of claim 93, further comprising a series of computer modules configured to execute between the steps executed by the computer module configured to receive and the a computer module configured to generate, the series of computer modules comprising:
a computer module configured to identify, based on at least the first and/or second information, tests for the user;
a computer module configured to send the identified tests to the user; and
a computer module configured to receive the results of the tests,
wherein the generating is based on the results of the tests.

103. A system configured to generate a beauty-related diagnosis for an individual, comprising:
a computer module configured to collecting personal information of a user, including at least (1) first information including a physical attribute of the user's visual appearance and (2) second information including an environmental characteristic of the user;
a computer module configured to receiving the personal information of the user;
a computer module configured to generating, from at least the first and second information, at least one recommended beauty product and a timing of the use of the beauty product;
a computer module configured to sending a beauty-related diagnosis to the user, the beauty-related diagnosis including the beauty product and the timing of the use of the beauty product;
wherein the environmental characteristic defines an external environment of the user and/or actions taken by the user.

104. The system of claim 103, wherein the environmental characteristic includes current environmental characteristics of the user and/or past environmental characteristics of the user.

105. The system of claim 103, wherein the environmental characteristic includes employment, smoking habit, diet, drinking habit, sleeping habit, exercise habit, and/or sun exposure.

106. The system of claim 103, wherein the a computer module configured to generating further comprises:
a computer module configured to assessing, based on the physical attribute of the user's visual appearance in the first information and the environmental characteristic of the user in the second information, a beauty regiment specific to the user; and
the beauty diagnosis includes the beauty regiment.

107. The system according to claim 103, wherein the physical attribute comprises at least one of a hair style, a hair color, a hair condition, a skin type, a skin condition, and/or a skin tone.

108. The system according to claim 103, wherein the a computer module configured to generating does not utilize an image of the user.

109. The system of claim 103, further comprising further comprising system configured to be executed between the steps executed by the a computer module configured to receiving and the a computer module configured to generating, the instructions comprising:
a computer module configured to identifying, based on at least the first and/or second information, tests for the user;
a computer module configured to sending the identified tests to the user; and
a computer module configured to receiving the results of the tests,
wherein the generating is based on the results of the tests.
